(19) United States
(12) Patent Application Publication
(10) Pub. No.: US 2003/0044299 A1
(43) Pub. Date: Mar. 6, 2003

(54) Fluid displacement apparatus and method

(76) Inventors: Wayne Thomas, Calgary (CA); Gary Morcom, Calgary (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 10/227,531

(22) Filed: Aug. 26, 2002

Related U.S. Application Data
(63) Continuation of application No. 09/584,367, filed on Jun. 1, 2000, now abandoned.

(51) Int. Cl. F04C 2/00; F03C 2/00; F01C 1/00

(52) U.S. Cl. 418/206.9; 418/1; 418/152; 418/206.7; 418/132

(57) ABSTRACT

A well production apparatus includes a down-hole gear pump and a transport assembly to which the gear pump is attached. The transport assembly is formed from a string of modular pipe assemblies having one or more passages for carrying production fluid from the bottom of the well to the surface. The passages can be arranged in a side-by-side configuration, and include pressure and return lines for driving the gear pump. The gear pump includes a hydraulically driven motor that is ganged with a positive displacement gear set. Both the motor and the pumping section have ceramic wear surfaces, the ceramic being chosen to have coefficients of thermal expansion corresponding to the coefficients of thermal expansion of the gear sets. The pumps and rotors have ceramic bushings rather than ball or journal bearings, and are operable under abrasive conditions.

### FIELD OF INVENTION

This invention relates generally to the field of well production apparatus such as used, for example, in down-hole pumping systems in wells. It also relates to pumping apparatus and methods for use of that apparatus.

### BACKGROUND OF THE INVENTION

Specific challenges arise in oil production when it is desired to extract heavy, sandy, gaseous or corrosive high temperature oil and water slurries from underground wells. These slurries to be pumped range over the breadth of fluid rheology from highly viscous, heavy, cold crude to hot thermal fluids. Recent technological advances have permitted well to be sunk vertically, and then to continue horizontally into an oil producing zone. Thus wells can be drilled vertically, on a slant, or horizontally. To date, although equipment is available to drill these wells, at present there is a need for a relatively efficient, and reasonably economical means to extract slurries from wells of these types.

In particular, it would be desirable to have a type of pump that would permit relatively efficient extraction of oil slurries from underground well bores that include horizontal and steam assisted gravity drainage (SAGD) or non-thermal conventional wells. In one SAGD process twin horizontal wells are drilled in parallel, one somewhat above the other. Steam is injected into the upper bore. This encourages oil from the adjacent region of the oil bearing formation to drain toward the lower bore. The production fluids drawn from the lower bore can then be pumped from the lower bore to the surface.

It is advantageous to match the pumping draw down of the lower bore to the rate of steam injection used in the upper bore. This will depend on the nature of the oil bearing formation, the viscosity of the oil and so on. If the rates can be matched to achieve a relative balance, the amount of steam pressure required can be reduced, thus reducing the power of the steam injection system required, and resulting in a more economical process.

Pumping the production oil or slurry from the lower horizontal bore presents a number of challenges. An artificial lift, or pumping, system must be able to operate even when the “liquid” to be pumped is rather abrasive. For example, some design criteria are based on slurries that may contain typically 3% by weight, and for short periods as much as 30% by weight, of abrasives, such as sand The pumping technology must be capable of handling a high volume of formation solids in the presence of high gas oil ratios (GOR). The system may well be called upon to handle slugs of hydrocarbon gas and steam created by flashing of water into vapour. On occasion the system may run dry for periods of time. As such, it is desirable that the system be capable of processing gases, and of running “dry”. It is also desirable that a pump, and associated tubing, be able to operate to a depth of 1000 M below well-head, or more, with an allowance of 100 psi as the minimum flow-line input pressure. It is also desirable that the equipment be able to operate in chemically aggressive conditions where pH is +/−10.

Further still, it would be advantageous to be able to cope with a large range of viscosities—from thick, viscous fluids to water, and at relatively high temperatures. The chosen equipment should be operable in both vertical and horizontal well bores.

Another requirement is the ability to pump all of the available fluid from the well bore. To that end it is advantageous to be able to operate the pump as far as possible in depth into a horizontal section. The system needs to be able to operate at high volume capacities, i.e., high volumetric flow rates, and to operate reasonably well under saturated steam conditions while processing hydrocarbon gases. As far as the inventors are aware, there is at present no artificial lifting equipment that addresses these problems in a fully satisfactory manner. It would be desirable to have a relatively efficient high temperature, high volume pumping system that can accommodate a large range of production requirements, with the capability of being installed into, and operating from, the horizontal section of a well bore.

Other artificial lift systems have been tried. For example, one known type of pump is referred to as a “Pump Jack”. It employs sucker rod pumping with a down-hole plunger pump. This is a reciprocating beam pumping system that includes a surface unit (a gearbox, Pittman arms, a walking beam, a horsehead and a bridle) that causes a rod string to reciprocate, thereby driving a down-hole plunger pump.

Pump jack systems have a number of disadvantages. First, it is difficult to operate a down-hole reciprocating rod pump in a horizontal section because of the reliance on gravity to exert a downward force on the pump plunger. Further, a horizontal application may tend to cause increased pump wear due to curvature in the pump barrel (to get to the horizontal section) and increased sucker rod and tubing wear. Second, down-hole pumps are susceptible to damage from sand, high temperature operation, and other contaminants. Third, plunger pumps are prone to gas lock. Fourth, the downward stroke of the pump rod, being governed by gravity, is subject to “rod float”. That is, as the length of the rod increases, the rod itself has sufficient resiliency, and play, that the motion transmitted from the surface is not accurately copied at the plunger—it may be out of phase, damped, or otherwise degraded so that much pumping effort is wasted. Fifth, pump jacks tend to require relatively extensive surface site preparation. Horizontal units tend to require larger than normal pump units because of the need to activate (i.e., operate) the rod string around the bend of the “build section” as well as to lift the weight of the rod string.

Another type of pump is the progressive cavity pump, or screw pump. In this type of pump a single helical rotor, usually a hard chrome screw, rotates within a double helical synthetic stator that is bonded within a steel tube. Progressive cavity pumps also have disadvantages. First, they tend not to operate well, if at all, at high temperatures. It appears that the maximum temperature for continuous operation in a well bore is about 180 F. (80 C.). It is desirable that the pump be able to operate over a range of −30 to 350 C. (−20 to 650 F.), and that the pump be able to remain in place during steam injection. Second, progressive cavity pumps tend not to operate well “dry”. It is desirable to be able to purge hydrocarbon gases, or steam created by flashing water into vapour. As far as the present inventors are aware, progressive cavity pumps have not been capable of operation in high GOR conditions. Further, the synthetic stator material of some known pumps appears not to be suitable for operation with aromatic oils. Due to the design of the screws, and their friction fit, progressive cavity pumps tend to have little, if any, ability to generate high pressures, thereby restricting their use to relatively shallow wells. In addition, progressive cavity pumps tend to be prone to wear between the rotor and the stator, and tend to have relatively short service run lives between overhauls. Progressive cavity pumps do not appear to provide high operational efficiency.

Electric submersible pumps (ESP) include a down-hole electric motor that rotates an impeller (or impellers) in the pump, thereby generating pressure to urge the fluid up the tubing to the surface. Electric submersible pumps tend to operate at high rotational speeds, and tend to be adversely affected by inflow viscosity limitations. They tend not to be suitable for use in heavy oil applications. Electric submersible pumps tend to be susceptible to contaminants. Electric submersible pumps are not, as far as the inventors are aware, positive displacement pumps, and consequently are subject to slippage and a corresponding decrease in efficiency. The use of electric submersible pumps is limited by horsepower and temperature restrictions.

Jet pumps typically employ a high pressure surface pump to transmit pumping fluid down-hole. A down-hole jet pump is driven by this high pressure fluid. The power fluid and the produced fluid flow together to the surface after passing through the down-hole unit. Jet pumps tend to have rather lower efficiency than a positive displacement pump. Jet pumps tend to require higher intake pressures than conventional pumps to avoid cavitation. Jet pumps tend to be sensitive to changes in intake and discharge pressure. Changes in fluid density and viscosity during operation affect the pressures, thereby tending to make control of the pump difficult. Finally, jet pump nozzles tend to be susceptible to wear in abrasive applications.

Gas lift systems are artificial lift processes in which pressurised or compressed gas is injected through gas lift mandrels and valves into the production string. This injected gas lowers the hydrostatic pressure in the production string, thus establishing the required pressure differential between the reservoir and the well-bore, thereby permitting formation fluids to flow to the surface. Gas lift systems tend to have lower efficiencies than positive displacement pumps. They tend be uncontrollable, or poorly controllable, under varying well conditions, and tend not to operate effectively in relatively shallow wells. Gas lift systems only have effect on the hydrostatic head in the vertical bore, and may tend not to establish the required drawdown in the horizontal bore to be beneficial in SAGD application. Further, gas lift systems tend to be susceptible to gas hydrate problems. The surface installation of a gas lift system may tend to require a significant investment in infrastructure—a source of high pressure gas, separation and dehydration facilities, and gas distribution and control systems. Finally, gas lift systems tend not to be capable of achieving low bottom-hole producing pressures.

Operation of a pump at a remote location in a bore hole also imposes a number of technical challenges. First, the pump itself can not be larger in diameter than the well bore. In oil and gas well drilling, for example, it can only be as large as permitted by the well-head blow-out preventer. A typical casing may have a diameter of 140 to 178 mm (5½ to 7 inches). A typical production tube has a diameter in the range of 73 to 89 mm (2¾ to 3½ inches). Providing power to a down-hole pump is also a challenge. An electric motor may burn out easily, and it may be difficult to supply with electrical power at, for example, ten thousand feet (3000 m) distance along a bore given significant line losses. A pneumatic or hydraulic pump can be used, provided an appropriate flow of working fluid is available under pressure. Whatever type of pump is used, it may tend to need to be matched in a combination with the available power delivery system.

In a number of applications, such as oil or other wells, it is desirable to conduct one or more types of fluid down a long tube, or string of tubing, while conducting another flow, or flows, in the opposite direction. Similarly, it may be advantageous to use a passageway, or a pair of passageways to conduct one kind of fluid, and another passageway for electrical cabling whether for monitoring devices or for some other purpose, or another pair of passageways for either pneumatic or hydraulic power transmission. In oil field operations it may be desirable to have a pair of passageways as pressure and return lines for hydraulic power, another line, or lines, for conveying production fluids to the surface, perhaps another line for supplying steam, and perhaps another line for carrying monitoring or communications cabling.

One method of achieving this end is to use concentrically nested pipes, the central pipe having a flow in one direction, the annulus between the central pipe and the next pipe carrying another flow, typically in the opposite direction. It may be possible to have additional annulli carrying yet other flows, and so on. Although singular continuous coiled tubing has been used, the ability to run an inner string within an outer concentric string is relatively new, and may tend to be relatively expensive. This has a number of disadvantages, particularly in well drilling. Typically, in well drilling the outside diameter of the pipe is limited by the size of the well bore to be drilled. This pipe size is all the more limited if the drilling is to penetrate into pockets of liquid or gas that are under pressure. In such instances a blow-out preventer (BOP) is used, limiting the outside diameter of the pipe. Typically, a drill string is assembled by adding modules, or sections of pipe, together to form a string. Each section is termed a “joint”. A joint has a connection means at each end. For example, one end (typically the down-hole end) may have a male coupling, such as an external thread, while the opposite, well-head, end has a matching female coupling, such as a union nut. It is advantageous in this instance to have a positive make-up, that is, to be able to join the “joints” without having to spin the entire body of the joint, but rather to have the coupling rotate independently of the pipe.

A limit on the outside diameter of the external pipe casing imposes inherent limitations on the cross-sectional area available for use as passageways for fluids. In some instances three or four passages are required. For example, this is the case when a motive fluid, whether hydraulic oil or water, is used to drive a motor or pump, requiring pressure and return lines, while the production fluid being pumped out requires one or more passages. The annulus width for four passages nested in a 3.5 inch tube is relatively small. The inventors are unaware of any triple or quadruple concentric tube string that has been used successfully in field operations.

As the depth of the well increases, the downhole pressure drop in the passages also increases. In some cases the well depth is measured in thousands of metres. The pressure required to force a slurry, for example, up an annular tube several kilometres long, may tend to be significant. One way to reduce the pressure drop is to improve the shape of the passages. For example, in the limit as an annulus becomes thin relative to its diameter, the hydraulic diameter of the resultant passage approaches twice the width, or thickness, of the annulus. For a given volumetric flow rate, at high Reynolds numbers pipe losses due to fluid friction vary roughly as the fourth power of diameter. Hence it is advantageous to increase the hydraulic diameter of the various passageways. One way to increase the hydraulic diameter of the passage is to bundle a number of tubes, or pipes, in a side-by-side configuration within an external retainer or casing in place of nested annulli. The overall cross-sectional area can also be improved by dividing the circular area into non-circular sectors, such as passages that have the cross-section shape of a portion of a pie.

Another important design consideration in constructing a pipe for deep well drilling, or well drilling under pressure, is that the conduit used be suitable for operation in a blow out preventer. This means that the pipe must be provided in sections, or joints, that can be assembled progressively in the blow out preventer to create, eventually, a complete string thousands, or tens of thousands, of feet long. It is important that the sections fit together in a unique manner, so that the various passages align themselves—it would not do for an hydraulic oil power supply conduit of one section to be lined up with the production fluid upward flow line of an adjacent section. Further, given the pressures involved, not only must the passage walls in each section be adequate for the operational pressure to which they are exposed, but the sections of pipe must have a positive seal to each other as they are assembled. Further still, given the relatively remote locations at which these assemblies may be used, and possibly harsh environmental conditions, the sections must go together relatively easily. It is advantageous to have a “user friendly” assembly for ease of pick-up, handling, and installation, that can be used in a conventional oil rig, for example.

Some of the tube passages must be formed in a manner to contain significant pressure. For an actual operating differential pressure in the range of 0-2000 p.s.i. it may be desirable to use pipe that can accommodate pressures up to, for example, 8,000 p.s.i. seamless steel pipe can be obtained that is satisfactory for this purpose. Electrical resistance welded pipe (ERW) that is suitable for this purpose can also be obtained. The steel pipe can then be roll formed to the desired cross-sectional shape.

### SUMMARY OF THE INVENTION

In an aspect of the invention there is a fluid displacement assembly having a first gear, a second gear, and a housing having a chamber defined therein to accommodate said gears. The first and second gears are mounted within the housing in meshing relationship. The housing has an inlet by which fluid can flow to the gears and an outlet by which fluid can flow away from the gears. The gears are operable to urge fluid from the inlet to the outlet, and at least a portion of the housing is made from a ceramic material.

In an additional feature of that aspect of the invention, the assembly is operable at temperatures in excess of 180° F. In another additional feature, the assembly is operable at temperatures at least as high as 350° F. In another additional feature, the ceramic material is part of a ceramic member, and is mounted within a casing. In still another feature, the ceramic material has a compressive pre-load.

In yet another feature the first and second gears are spur gears. In an alternative feature the first gear is a spur gear and said second gear is a ring gear mounted eccentrically about said first gear. In a further feature, a ceramic partition member is mounted within the ring gear between the first gear and the second gear. In a further alternative feature, the first and second gears are a pair of gerotor gears.

In a further additional feature of the invention, the gears are sandwiched between a pair of first and second yokes mounted to either axial sides thereof Each of the yokes has a pair of first and second bores formed therein to accommodate the first and second shafts. Each of the yokes has a gear engagement face located next to the gears. Each of the gear engagement faces has a peripheral margin conforming to the arcuate portions of the internal wall of the housing, and each of the yokes is biased to lie against the gears.

In another aspect of the invention there is a gear pump having a first gear, a second gear, and a housing having a chamber defined therein to accommodate said gears. The first gear is mounted on a shaft having an axis of rotation. The first and second gears are mounted in the housing in meshing engagement. The housing has an inlet by which fluid can flow to the gears and an outlet by which fluid can flow away from the gears, and the shaft is mounted in ceramic bushings within the housing. In another feature of that aspect of the invention, the ceramic bushings include ceramic inserts mounted in a metal body.

In a further aspect of the invention there is a gear pump having a first gear, a second gear, and a housing having a cavity defined therein to accommodate said first and second gears. The first and second gears are mounted in meshing relationship within the housing. The housing has an inlet by which fluid can flow to the gears and an outlet by which fluid can flow away from the gears. The gears are operable to displace fluid from the inlet to the outlet. The first gear is mounted on a first shift having a first axis of rotation. The first and second gears each have a first end face lying in a first plane perpendicular to the axis of rotation. A moveable wall is mounted within the housing to engage the first end faces of the gears. The moveable wall has a ceramic surface oriented to bear against the first end faces of the first and second gears.

In an additional feature of that aspect of the invention, the moveable wall is a head of a piston and, in operation, the piston is biased toward the first end faces of the first and second gears. In another feature the piston is hydraulically biased toward the gears. In another feature, each of the first and second gears has a second end face lying in a second plane spaced from the first plane, and a second moveable wall is mounted within the housing to bear against the second end faces of the first and second gears. In another feature, both of the moveable walls are biased toward the gears. In another additional feature, the end walls are heads of respective first and second pistons, the pistons being moveable parallel to the axis of rotation. In a further additional feature, the ceramic surface is a plasma carried on a metal substrate.

In another additional feature, the second gear is mounted on a second shaft extending parallel to the first shaft. The ceramic surface is formed on a body having a first bore defined therein to accommodate the first shaft and a second bore defined therein to accommodate the second shaft, the body being displaceable along the shafts. In a further feature, at least one of the bores has a wall presenting a ceramic bushing surface to one of the shafts. In another feature the body has a passageway formed therein to facilitate flow of fluid. In a further feature, the body has passageways formed therein to facilitate flow of fluid to and from the inlet and the outlet.

In still another aspect of the invention, there is a gear pump assembly having a pair of first and second mating gears, mounted on respective first and second parallel shafts in meshed relationship; a housing for the gears, the housing having an inlet by which fluid can flow to the gears and an outlet by which fluid can flow away from the gears. The gears are operable to urge fluid from the inlet to the outlet. the housing includes a gear surround having two overlapping bores defined therein conforming to the gears in meshed relationship, and the surround presents a ceramic internal surface to said gears.

In an additional feature the surround is formed of a transformation toughened zirconia. In a further feature, the surround is made of a ceramic monolith. In another feature, the surround has a compressive pre-load. In a still further feature, the surround is mounted within a shrink fit casing member. In yet another feature, the ceramic monolith has a co-efficient of thermal expansion corresponding to the co-efficient of thermal expansion of the gears. In another additional feature, the gear pump assembly has a movable endwall mounted to ride in the overlapping bores.

In another additional feature, the shafts each have an axis of rotation and said gears each have first and second end faces lying in first and second spaced apart parallel planes, said parallel planes extending perpendicular to said axis. A movable piston is mounted to ride within the overlapping bores, and the piston has a face oriented to engage the first end faces of the gears.

In another aspect of the invention, there is a gear pump assembly having a first gear mounted on a first shaft, the first shaft having a first axis of rotation; a second gear mounted on a second shaft, the second shaft having a second axis of rotation; the axes lying in a common plane. The first and second gears are mounted to mesh together in a first region between the axes. A gear surround has an internal wall defining a cavity shaped to accommodate the gears. The internal wall has a first portion formed on an arc conforming to the first gear and a second portion, formed on another arc, to conform to the second gear. The first and second portions lie away from the first region. The internal wall has a third portion between the first and second portions. The third portion lies abreast of the first region and has a first passageway formed therein to carry fluid to the cavity adjacent to the gears to one side of the plane. The internal wall has a fourth portion lying between the first and second portions. The fourth portion lies abreast of the first region to the other side of the plane from the third portion. The fourth portion has a second passageway formed therein to carry fluid from the cavity. The gears are operable to transfer fluid from the first passageway to the second passageway.

In another aspect of the invention, there is a well production apparatus for transporting a production fluid from a downhole portion of a well to a well head. The well production apparatus includes a transport assembly having a first end located in the downhole portion of the well and a second end located at the wellhead, and a gear pump mounted to said first end of said transport assembly. The transport assembly has at least one passageway defined therein for conducting production fluid from the first end to the second end. The transport assembly has a power transmission member extending between the first and second ends thereof. The transmission member is connected to the gear pump to permit the gear pump be driven from the wellhead, and the gear pump is operable to urge production fluid from the first end of the transport assembly to the wellhead.

In still another aspect of the invention, there is a method of moving production fluid from a well to a wellhead, the method including the steps of mounting a gear pump to a first end of a transport apparatus from the wellhead; introducing the transport apparatus into the well and locating the gear pump in a downhole production region of the well; and driving the gear pump from outside the well to urge production fluid from the production region to the wellhead.

In an additional feature of that aspect of the invention, the method includes the steps of providing a passageway in the transport apparatus for carrying production fluid from the production region to the wellhead; and providing a power transmission member to carry power for the wellhead to the gear pump.

These and other aspects and features of the invention are described herein with reference to the accompanying illustrations.

### BRIEF DESCRIPTION OF THE DRAWINGS

FIG. 1a shows a general schematic illustration of a steam assisted gravity drainage oil productions system having a down-hole production unit;

FIG. 1b shows a schematic illustration of the down-hole production unit of FIG. 1a.

FIG. 2a shows a side view of the down-hole production unit of FIG. 1a;

FIG. 2b shows a side view of the down-hole production unit of FIG. 2a with its external casings removed;

FIG. 2c shows a longitudinal cross-section of the down-hole production unit of FIG. 2a;

FIG. 3a shows a cross-section taken on section ‘3a -3a’ of FIG. 2b;

FIG. 3b shows a end view of FIG. 2a;

FIG. 3c shows a cross-section taken on section ‘3c-3c’ of FIG. 2c

FIG. 3d shows a cross-section taken on section ‘3d-3d’ of FIG. 2c;

FIG. 3e shows a cross-section taken on section ‘3e-3e’ of FIG. 2c;

FIG. 3f shows a cross-section taken on section ‘3f-3f’ of FIG. 2c;

FIG. 3g shows a cross-section taken on section ‘3g-3g’ of FIG. 2c;

FIG. 3h shows a cross-section taken on section ‘3h-3h’ of FIG. 2c;

FIG. 3i shows a cross-section taken on section ‘3i-3i’ of FIG. 3d;

FIG. 4a shows an end view of a top or intermediate stage motor unit of the down-hole production unit of FIG. 2b;

FIG. 4b shows a cross-section on section ‘4b-4b’ of FIG. 4a;

FIG. 4c shows a cross-section on section ‘4c-4c’ of FIG. 4a;

FIG. 4d shows a side view of a fitting of FIG. 4a;

FIG. 4e shows an exploded view of the fitting of FIG. 4d;

FIG. 4f shows an end view of the fitting of FIG. 4d;

FIG. 4g shows a cross-sectional view taken on section ‘4g-4g’ of FIG. 4f;

FIG. 5a shows an end view of a bottom stage motor unit of the down-hole production unit of FIG. 2b;

FIG. 5b shows a cross-section on section ‘5b-5b’ of FIG. 5a;

FIG. 5c shows a cross-section on section ‘5c-5c’ of FIG. 5a;

FIG. 6a shows an end view of a top or intermediate stage pump unit of the down-hole production unit of FIG. 2b;

FIG. 6b shows a cross-section on section ‘6b-6b’ of FIG. 6a;

FIG. 6c shows a cross-section on section ‘6c-6c’ of FIG. 6a;

FIG. 7a shows an end view of a bottom stage pump unit of the down-hole production unit of FIG. 2b;

FIG. 7b shows a cross-section on section ‘7b-7b’ of FIG. 7a;

FIG. 7c shows a cross-section on section ‘7c-7c’ of FIG. 7a;

FIG. 8a shows an exploded view of a positive displacement gear pump assembly of the down-hole production unit of FIG. 2a;

FIG. 8b shows an end view of the gears of the gear assembly of FIG. 8a;

FIG. 8c shows an assembled perspective view of the positive displacement gear pump of FIG. 8a;

FIG. 8d shows an exploded view of an alternate positive displacement gear assembly to that of FIG. 8a;

FIG. 8e shows an end view of the gears of the gear assembly of FIG. 8d;

FIG. 8f shows an exploded view of a further alternate positive displacement gear assembly to that of FIG. 8a;

FIG. 8g shows an end view of the gear assembly of FIG. 8f;

FIG. 8h shows a perspective view of an alternate piston for the assembly of FIG. 8a;

FIG. 8i shows a perspective view of another alternate piston for the assembly of FIG. 8a;

FIG. 9a shows a side view of an assembled multi-passage pipe assembly according to an aspect of the present invention;

FIG. 9b shows an isometric view of a pair of the multi-passage pipe assemblies of FIG. 9a joined together;

FIG. 9c shows an exploded isometric view of the pair of multi-passage pipe assemblies of FIG. 9b in a separated condition;

FIG. 9d is a cross-sectional view of the pipe assemblies of FIG. 9a showing the join;

FIG. 10a is an isometric view of a tube member of the multi-passage pipe assembly of FIG. 9a;

FIG. 10b is a cross-sectional view of the tube member of FIG. 10a;

FIG. 11a is a plan view of a seal for the pipe assemblies of FIG. 9a;

FIG. 11b is a diametral cross-section of the seal of FIG. 11a;

FIG. 11c is a detail of a portion of the cross-section of the seal of FIG. 11b;

FIG. 12 shows a cross-sectional view of the tube assembly of FIG. 9a taken on section ‘12-12’;

### DETAILED DESCRIPTION OF THE INVENTION

The description which follows, and the embodiments described therein, are provided by way of illustration of an example, or examples of particular embodiments of the principles of the present invention. These examples are provided for the purposes of explanation, and not of limitation, of those principles and of the invention. In the description which follows, like parts are marked throughout the specification and the drawings with the same respective reference numerals. The drawings are not necessarily to scale and in some instances proportions may have been exaggerated in order more clearly to depict certain features of the invention.

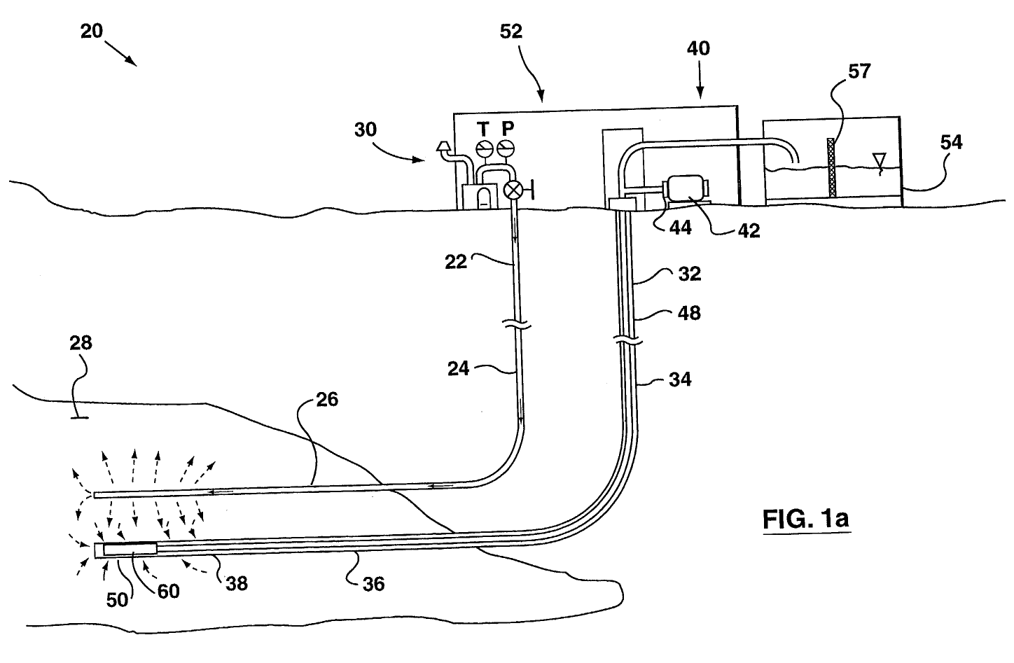

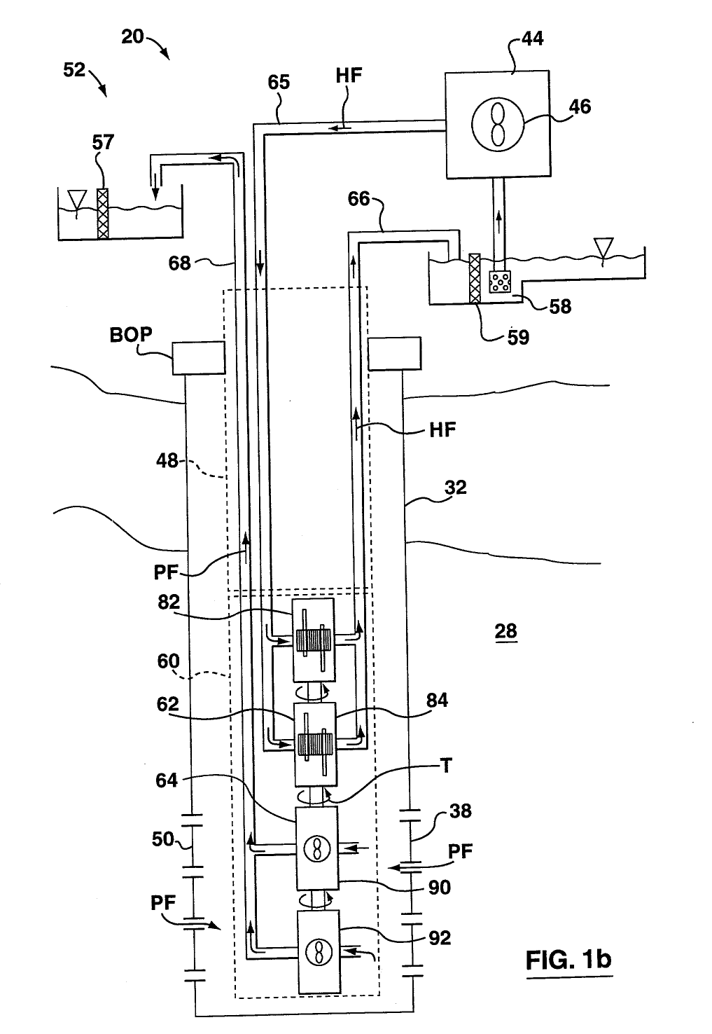

By way of a general overview, an oil extraction process apparatus is indicated generally in FIG. 1a as 20. It includes a first bore 22 having a vertical portion 24 and a horizontal portion 26. Horizontal portion 26 extends into an oil bearing formation 28 at some distance below the surface. For the purposes of illustration, the vertical scale of FIG. 1 is distorted. The actual depth to horizontal portion, 26 may be several kilometres. A steam generating system 30 is located at the well head and is used to inject steam at temperature T and pressure P down bore 22. Horizontal portion 26 is perforated to permit the steam to penetrate the adjacent regions of formation 28.

A second well bore is indicated as 32. It has a vertical portion 34 and a horizontal portion 36, corresponding generally to vertical portion 24 and horizontal portion 26 of bore 22. Horizontal portion 36 runs generally parallel to, and somewhat below, horizontal portion 26. A section (or sections) 38 of horizontal portion 36 runs through oil bearing formation 28, and is perforated to permit production fluid to drain from formation 28 into section 38. The injection of steam into formation 28 through portion 26 is undertaken to encourage drainage of oil from formation 28. It will be appreciated that alternative types of well can also have analogous vertical or inclined perforated sections.

A production fluid lift system in the nature of a pumping system is designated generally as 40. It is shown schematically in FIG. 1b. It includes a power generation system 42 at the well head, in the nature of a motor 44 that drives a hydraulic pump 46. A transport system 48 carries power transmitted from system 42 to the downhole end 50 of bore 32, and carries production fluid from downhole end 50 to the well head 52. A collection and separation system, such as a holding tank 54 is located at the well head to receive the production fluid as it exits transport system 48. A hydraulic reservoir 56 receives returned hydraulic fluid HF, and has a sump whence hydraulic fluid is again drawn into hydraulic pump 46. Respective filters are indicated as 57 and 59.

Transport system 48 terminates at a downhole production unit 60, described in greater detail below. Production unit 60 includes a power conversion unit, namely a hydraulic motor section 62, that is driven by the pressurized hydraulic fluid (such as water) carried in pressure line 65 and return line 66 by transport system 48 from and to hydraulic pump 46 to convert the transported power to a mechanical output, namely torque T in a rotating output shaft. Production unit 60 also includes a pump section 64 that is driven by hydraulic motor 62, pump section 64 being operable to urge production fluids PF to the surface by way of production fluid lift line 68 through transport system 48. A blow out preventer indicated as BOP, engages transport system 48 at well head 52 since the well pressure, and temperature, may be well above atmospheric.

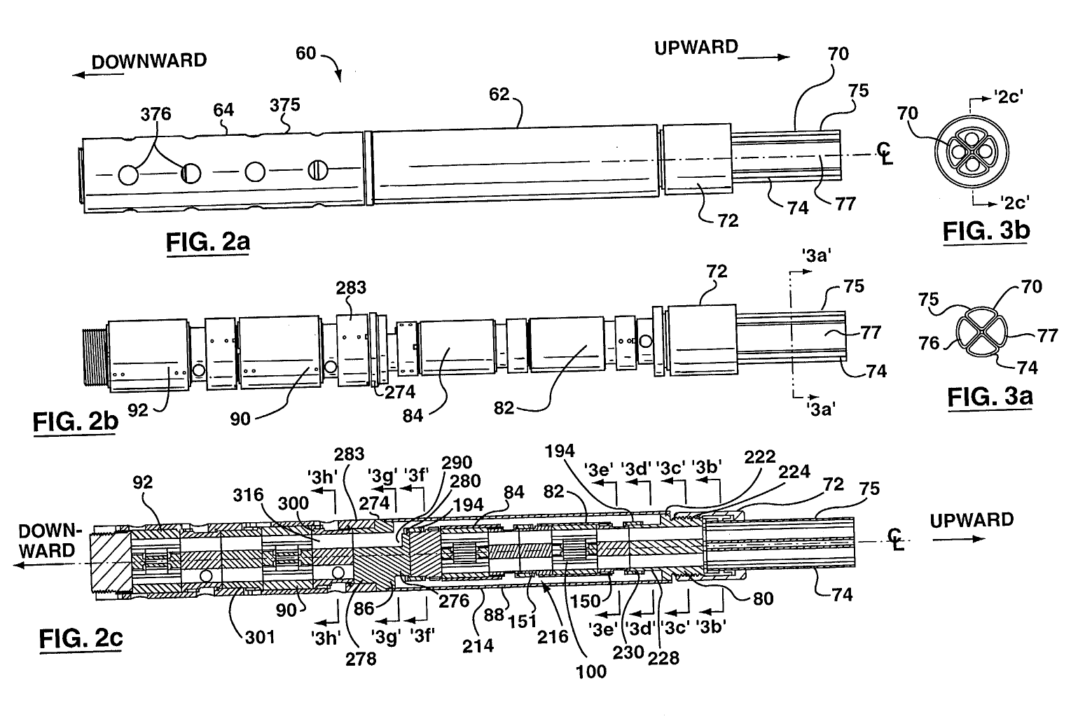

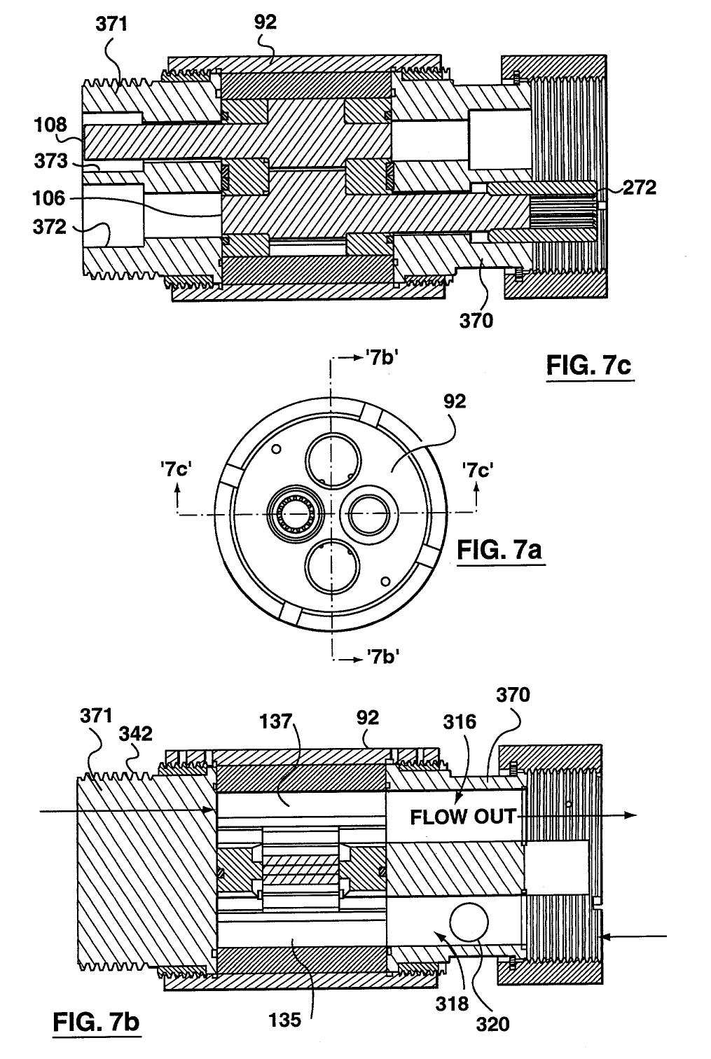

Downhole production unit 60 is shown in greater detail in the illustrations of FIGS. 2a to 8c. As a note of preliminary explanation, the frame of reference for production unit 60, when deployed in production, is a well bore that can be vertical, inclined or horizontal. In the explanation that follows, whether the well is horizontal, or vertical, or inclined, references to up, or upward, mean along the bore toward the wellhead. Similarly, references to down, or downward, mean away from the well head. In a consistent manner, when the unit is being assembled into a long string at the well head, the orientation of up and down corresponds to how personnel at the well head would see the unit, or its components as they are being assembled and introduced into the well. For the purposes of operation, the local portion of the well bore occupied at any one time by production unit 60 approximates a round cylinder having a central longitudinal axis CL, defining an axial direction either up or down, with corresponding radial and circumferential directions being defined in any plane perpendicular to the axial direction.

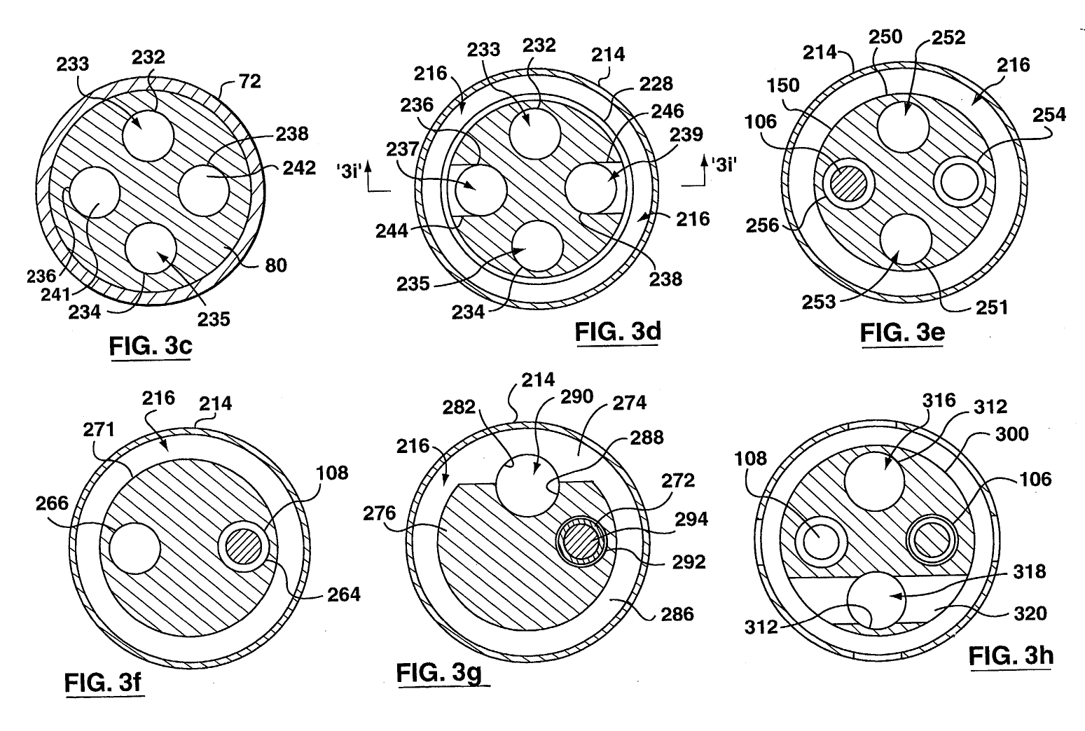

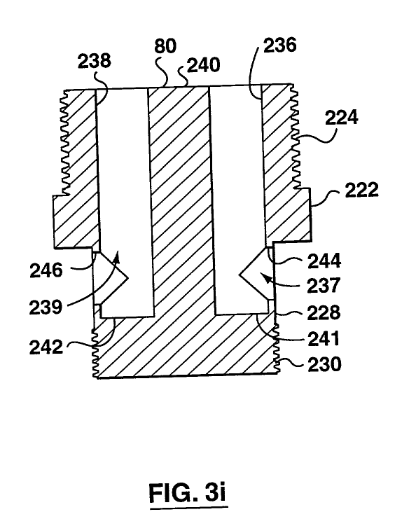

Downhole production unit 60 is shown, as assembled, in FIGS. 2a, 2b and 2c. Starting at the upward end, the endmost portion of transmission system 48 is shown with casing removed as 70. Portion 70 has four conduit members in a bundle that terminates at a female coupling 72. The four conduit members, identified in FIG. 3a as 74, 75, 76 and 77 and carry, respectively, in conduit member 74, downflowing hydraulic motor fluid (the pressure supply line 65); in conduit member 75, upflowing hydraulic. motor fluid (the return line 66); and in conduits 76 and 77, pumped production fluid flowing upward, (i.e., the production fluid lift line 68 to the well head).

Female coupling 72 connects with the male end coupling of motor section 62. Motor section 62 has a first, or upward transition coupling in the nature of a motor section inlet plate 80; a first motor unit namely upper motor assembly 82; a second motor unit namely lower motor assembly 84; a second, or lower transition coupling in the nature of a motor section outlet plate 86; and an external casing 88. Pump section 64 is connected to the lower end of motor section 62. Pump section 64 has a first, or upper, pump unit namely upper pump assembly 90, and a second, or lower, pump unit namely lower pump assembly 92. The direction of the various fluid flows through these units is described more fully below.

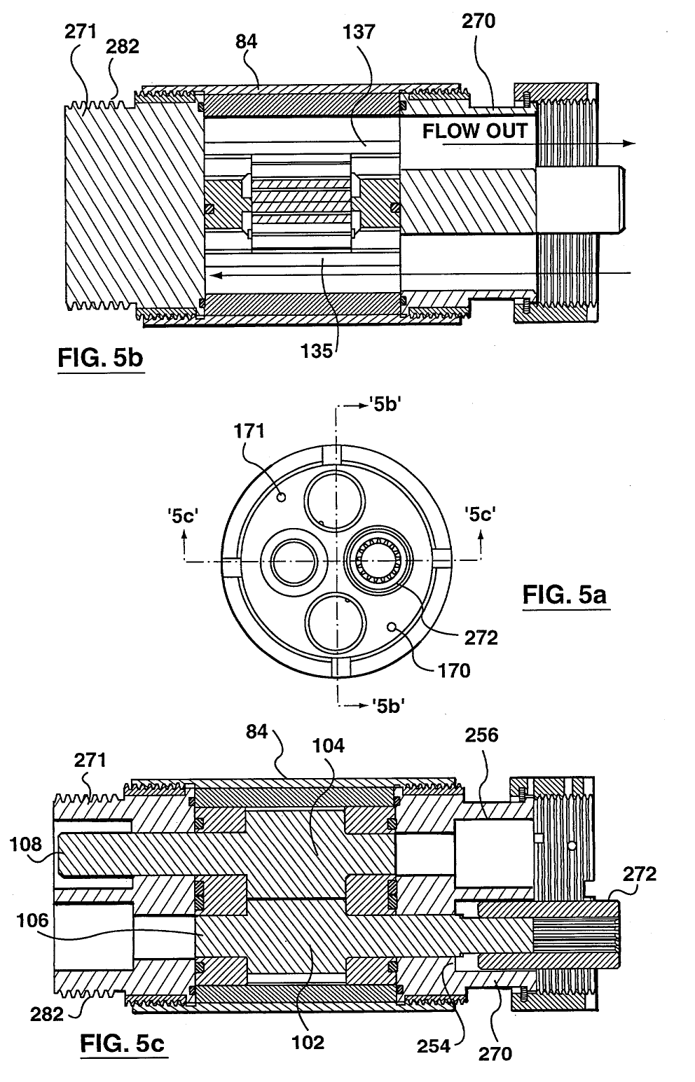

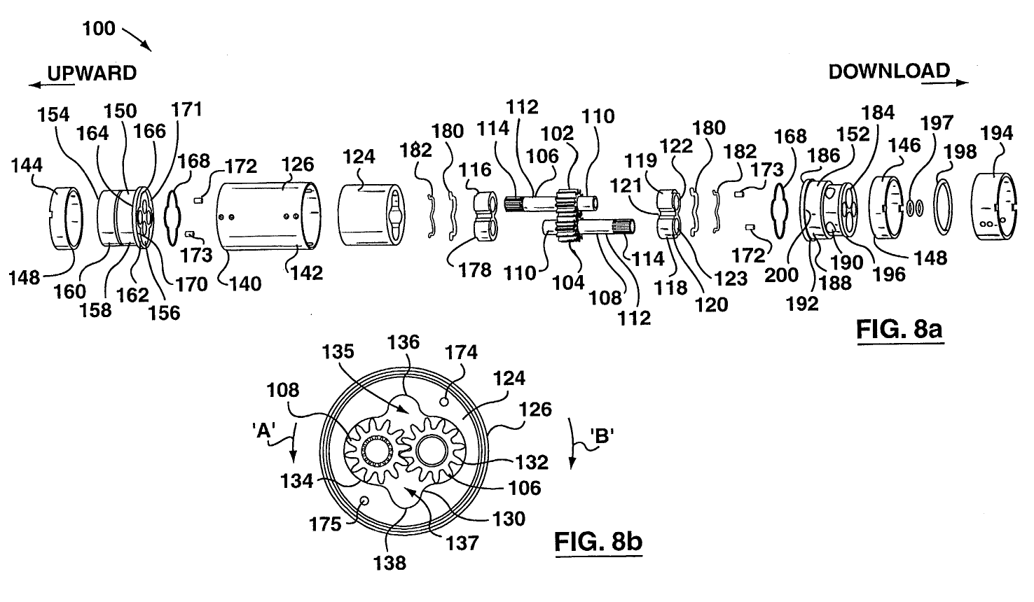

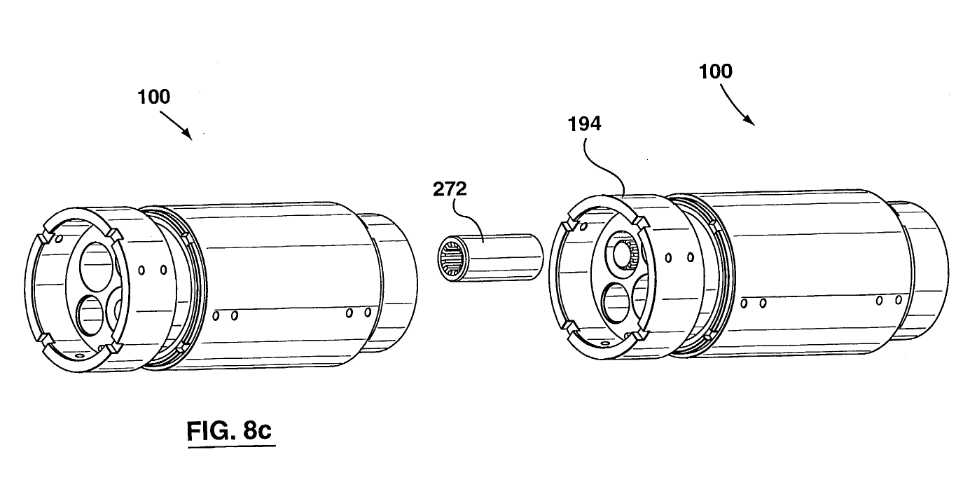

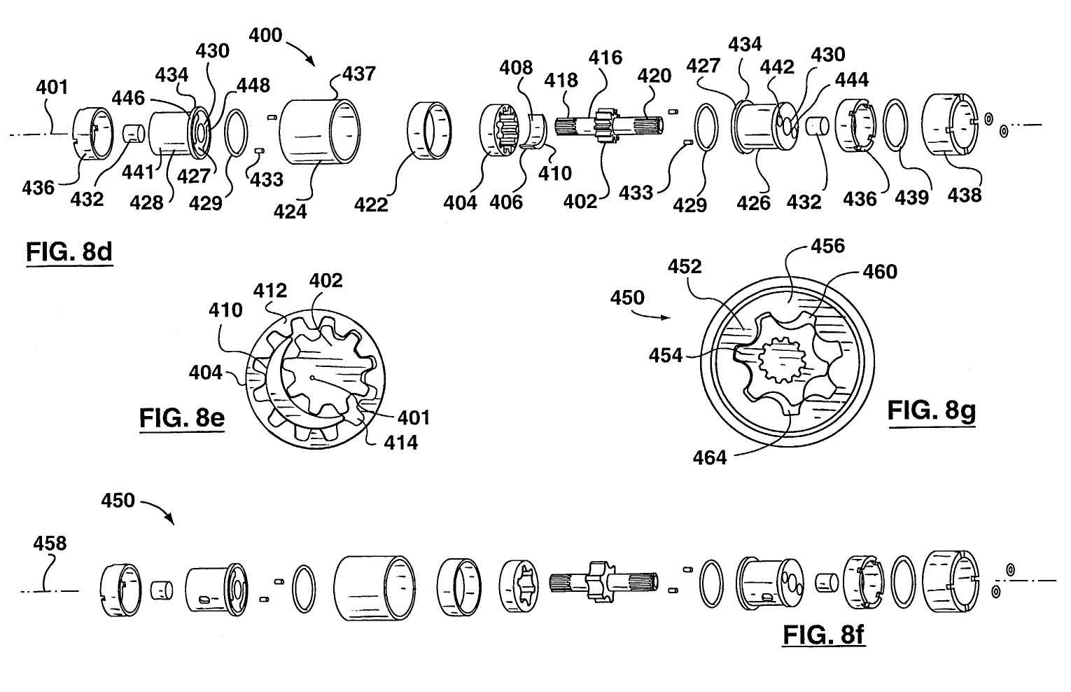

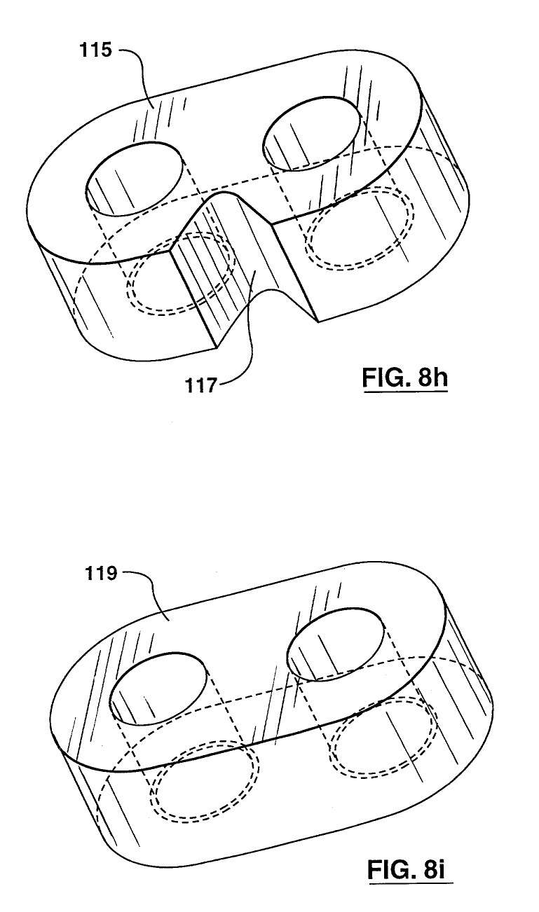

The basic unit of construction of each of first and second motor units 84 and 86 is a positive displacement gear assembly, 100, shown in detail in FIGS. 5a to 8a. Gear assembly 100 is shown in exploded view in FIG. 8a. First and second pump assemblies 90 and 92 employ positive displacement gear assemblies 101 which are almost identical to assembly 100 in construction but are, in the illustrated configuration, somewhat larger in diameter as shown in FIG. 2c, and assemblies 101 have thicker shrink fit casings 127. For the purposes of the present description, a description of the elements of assembly 100 will serve also to describe the components of pump assemblies 101.

As shown in FIG. 8a, gear assembly 100 includes a pair of matched first and second gears 102 and 104 mounted to respective stub shafts 106 and 108. Stub shafts 106 and 108 are parallel such that their axes lie in a common plane. When gears 102 and 104 engage, there is continuous line contact between mating lobes in a meshing region located between the axes of rotation of shafts 106 and 108 such that there is no clear passage between the engaging teeth. Stub shafts 106 and 108 are arranged such that gears 102 and 104 are mounted toward one end of their respective stub shafts, such that a short end 110 protrudes to one side of each gear, and a long end 112 protrudes to the other. Each long end 112 has a set of torque transmission members, in the nature of a set of splines 114 to permit torque to be received or transmitted as may be appropriate. Gears 102 and 104 are engaged such that the respective long ends of stub shafts 106 and 108 protrude to opposite sides of the matched gears, that is, one extending to in the upward axial direction, and one extending in the downward axial direction.

First and second pistons are indicated as 116 and 118. Each has a body having an eyeglass shape of first and second intersecting cylindrical lobes 119, 120 with a narrowed waist 121 inbetween. Each of the lobes has a circular cylindrical outer portion formed on a radius that closely approximates the tip radius of gears 102 and 104. Each body has a pair of parallel, first and second round cylindrical bores 122 and 123, formed in the respective first and second lobes, of a size for accommodating one or another end of stub shafts 106 and 108. The centers of the bores correspond to an appropriate centreline separation for gears 106 and 108. In the preferred embodiment of FIG. 8a, pistons 116 and 118 are made of steel with ceramic face plates for engaging the end faces of gears 102 and 104, and ceramic inserts that act as bushings for the respective ends of stub shafts 106 and 108.

Alternative embodiments of pistons can be used, as shown in FIGS. 8h and 8i, for example. In FIG. 8h, an alternative piston 115 is shown having a generally ovate form with a single relief 117 to accommodate adjacent fluid flow in the axial direction. In FIG. 8i, a further alternative piston 119 has an ovate form lacking a relief, such that the adjacent surround member carries has the flow passage formed entirely therewithin. Although pistons 116 and 118 are made of steel, as noted above, they could also be made from a metal matrix composite material (MMC) having approximately 20-30% Silicon Carbide by volume, with Aluminum, Nickel and 5% (+/−) Graphite, with ceramic surfaces for engaging gears 102 and 104.

Gears 102 and 104, shafts 106 and 108, and pistons 116 and 118, when assembled, are carried within a surrounding member in the nature of a ceramic surround insert 124. Insert 124 has a round cylindrical outer wall and is contained within a mating external casing 126. External casing 126 is a steel shrink tube that is shrunk onto insert 124 such that casing 126 has a tensile pre-load and ceramic insert 124 has a corresponding compressive preload, such as may tend to discourage cracking of insert 124 in operation, and may tend to enhance service life. Insert 124 has an internal, axially extending cylindrical peripheral wall 130 of a lobate cross-section defining gear set cavity therewithin.

It is preferred that insert 124 be formed of a transformation toughened zirconia (TTZ) stabilized with magnesium. However, other materials can be used depending on the intended use. Other ceramics that can be used included, but are not limited to, alumina or silicon carbide, or alternatively, a plasma coated steel. The ceramic chosen has a similar co-efficient of thermal expansion to gears 106 and 108, pistons 116 and 118 and surround shrink tube, casing 126, to be able to function at elevated temperatures. The ceramic material also tend to be relatively resistant to abrasives. The combination of high hardness, and thermal expansion similar to steel is desirable in permitting operation with abrasive production fluids at high temperatures.

Pistons 116 and 118 can be made from silicon carbide, as noted above, or reaction bonded silicon nitride, tungsten carbide or other suitable hard wearing ceramic with or without graphite for lubricity. These materials can be shrunk fit or braised to a metal surround of substrate for high temperature applications, or to a metal matrix material for low temperature applications.

Gears 102 and 104 are made from a tough material suited to high temperature and abrasive use, such as steel alloy EN30B, cast A10Q or Superimpacto (t.m.). The material can be carburized and subjected to a vanadium process for additional hardening.

Wall 130 has first and second diametrically opposed lobes 132 and 134 each having an arcuate surface formed on a constant radius (i.e., forming part of an arc of a circle), the centers of curvature in each case being the axis of rotation of stub shafts 106 and 108 respectively, and the radius corresponding to the tip radius of gears 106 and 108. As such, lobes 132 and 134 describe arcuate surface walls of a pair of overlapping bores centered on the axes of shafts 106 and 108 respectively. Pistons 116 and 118 fit closely within, and are longitudinally slidable relative to, lobes 132 and 134. Wall 130 also has a pair of first and second diametrically opposed transverse outwardly extending bulges, indicated as axial fluid flow accommodating intake and exhaust lobes 136 and 138 which define respective axially extending intake and exhaust (or inlet and outlet) passages. As shown in the cross-sectional view of FIG. 8b, when assembled, if the gears turn in the counter-rotating directions indicated by arrow ‘A’ for gear 106 and arrow ‘B’, fluid carried at the intake passage 135 defined between lobe 136 and the waist 121 of pistons 116 and 118 can occupy the cavity defined between successive teeth of gears 106 and 108, to be swept past arcuate wall lobes 132 and 134 respectively. However, as the gears mesh, the volume of the cavities between the teeth is reduced, forcing the fluid out from between the teeth and into the exhaust passage 137 defined between lobe 138 and the waist of piston 118.

Casing 126 has a longitudinal extent that is greater than insert 124, such that when insert 124 is installed roughly centrally longitudinally within casing 126, first and second end skirts 140 and 142 of casing overhang each end of insert 124 (i.e., the skirts extend proud of the end faces of insert 124). Each of skirts 140 and 142 is internally threaded to permit engagement by a retaining sleeve 144, 146. Retaining sleeves 144 and 146 are correspondingly externally threaded, having notches to facilitate tightening, and an annular shoulder 148 that bears against whichever type of end plate adapter may be used. In the example of FIG. 8a, a first end flow adapter fitting, or end plate, is indicated as end plate 150, and a second end flow adapter fitting, or second end plate, is indicated as 152. The internal features of plates 150 and 152 are described more fully below.

End plate 150 has a first end face 154, facing away from gears 106 and 108, and a second end face 156 facing toward gears 106 and 108. Externally, end plate 150 has a round cylindrical body having a smooth medial portion 158, a first end portion 160 next to end face 154, and a second end portion in the nature of a flange 162 next to second end face 156. Portion 160 is of somewhat smaller diameter than portion 158, and is externally threaded to permit mating engagement with, in general, a union nut of a next adjacent pump or motor section. Flange 162 has a circumferential shoulder 164 lying in a radial plane, such that when retaining ring 144 is tightened within casing 124, shoulder 148 of retaining ring 144 bears against shoulder 164, thus drawing end plate 150 toward gears 106 and 108.

Second end face 156 of plate 150 has a seal groove 166 into which a static seal 168 seats. Seal 168 is of a size and shape to circumscribe the entire lobate periphery of internal peripheral wall 130 of insert 124. Face 156 also has a pair of indexing recesses 170, 171 into which dowels pins 172 and 173 seat. Insert 124 has corresponding dowel pin recesses 174, 175, such that when assembled, dowel pins 172, 173 act as an alignment means in the nature of indexing pins, or alignment governors, to ensure alignment of plate 150 with insert 124 in a specific orientation. As described below, end plate 150 has a number of internal passages, and the correct alignment of those passages with stub shafts 106 and 108 and with passages 135 and 137 of insert 124 is required for satisfactory operation of unit 100. The outward face of piston 116, that is, face 178 which faces toward plate 150 (or 152) and away from gears 106 and 108, has a rebate against which an omega seal 180 can bear, with a seal backup 182 located behind seal 180. When retaining ring 144 is tightened, seals 180, 182 and 168 are all compressed in position. If the direction of rotation of gears 102 and 104 is reversed, the role of intake and exhaust is also reversed. The ability to reverse the direction of rotation of the gearset, or to operate the gearset as a motor, depends on the seals employed. Omega seals 180 of the preferred embodiment are mono-directional seals which tend to resist leakage past face 178 from passage 137 back to passage 135. They do not work equally well in the other direction.

End plate 152 has a first end face 184, facing away from gears 106 and 108, and a second end face 186 facing toward gears 106 and 108. Externally, end plate 152 has a round cylindrical body having a smooth medial portion 188, a first end portion 190 next to end face 184, and a second end portion in the nature of a flange 192 next to second end face 186. Portion 190 is of somewhat smaller diameter than portion 188, and is externally smooth to permit longitudinal travel of a mating female union nut 194. Portion 190 terminates in an end flange 196 having a shoulder that engages a spiral retaining ring 198 of nut 192 when nut 192 is tightened on an adjacent fitting of the next adjacent motor or pump section. Flange 192 has a circumferential shoulder 200 lying in a radial plane, such that when retaining ring 146 is tightened within casing 126, shoulder 148 of retaining ring 146 bears against shoulder 200, thus drawing end plate 152 toward gears 106 and 108. First end face 184 is also provided with O-ring seals 197 for sealing the connection between its own fluid passages (described below) and the passages of an adjoining fitting when assembled.

Second end face 186 of plate 152 has a seal groove 166 into which another static seal 168 seats. As above, seal 168 is of a size and shape to circumscribe the entire periphery of internal peripheral wall 130 of insert 124. Face 186 also has another pair of indexing recesses 170, 171 into which further dowels pins 172 and 173 seat. Insert 124 has corresponding dowel pin recesses 174, 175, such that when assembled, dowel pins 172, 173 act as an alignment means in the nature of indexing pins, or alignment governors, to ensure alignment of plate 152 with insert 124 in a specific orientation. As described below, end plate 152 has a number of internal passages, and the correct alignment of those passages with stub shafts 106 and 108 and with passages 135 and 137 of insert 124 is required for satisfactory operation of unit 100. The outward face of piston 118, that is, face 178 which faces toward plate 152 and away from gears 102 and 104, has a rebate against which an omega seal 180 can bear, with a seal backup 182 located behind seal 180. When retaining ring 146 is tightened, seals 180, 182 and 168 are all compressed in position, in the same manner as noted above.

When unit 100 is fully assembled, and in operation, pistons 116 and 118 are urged against the end faces of gears 102 and 104 by hydrodynamic pressure, such that hydraulic fluid will tend not to seep easily from the high pressure port to the low pressure port. Inasmuch as there are neither ball nor journal bearings, and inasmuch as the body of the assembly is predominantly hard, abrasion resistant ceramic, with tough, hardened steel fittings, the unit is able to operate at relatively high temperatures, that is, temperatures in excess of 180 F. The unit may tend also to be operable at temperatures up to 350 F. or higher.

As noted above, each of motor units 82 and 84 and each of pump units 90 and 92 employs a gear assembly unit 100. The difference between motor units 82 and 84 is in the respective transition plates used between the units. These plates act as fluid manifolds by which the various fluids are directed to the correct destinations.

Starting at the top, or upper, end of the string, transport system 48 ends at a first manifold, namely motor section inlet plate 80. Motor section 62 includes a pair of modular gear assemblies 100, ganged together, and motor section outlet plate 86. A round cylindrical casing 214 is welded to inlet plate 80 and outlet plate 86, leaving a generally annular passageway 216 defined between an outer peripheral wall, namely the inner face of casing 214, and the exterior surface of the ganged gear assemblies, which are designated as upper motor assembly 82 and a lower motor assembly 84.

As shown in FIGS. 2c, 2d, 3a, 3b, 3c, 3d, and 3k motor section inlet plate 80 has a cylindrical body having a medial flange 222 that extends radially outward to present a circumferential face about which one end of casing 214 is welded. To the upward side of flange 222, there is an externally threaded end portion 224 that mates with a female coupling 72 of transport system 48. To the other, downward side of flange 222 there is an intermediate portion 228 that has a smooth cylindrical surface, and, downwardmost, there is an externally threaded end portion 230 that mates with union nut 194 of upper motor assembly 82. Taken on the cross-sections of FIG. 3c, 3d and 3k, it can be seen that inlet plate 80 has first and second parallel, axially extending through bores 232 and 234 defining hydraulic fluid supply and return passages 233 and 235 which communicate with transport system supply tubes 75 and 74. Inlet plate 80 also has a pair of parallel, axially extending blind bores 236 and 238 let in from upward face 240, and which terminate at dead ends 241 and 242. Porting for bores 236 and 238 is provided by perpendicular blind cross bores 244 and 246 extend radially inward through the wall of intermediate portion 228. When assembled, bores 236 and 238, and cross-bores 244 and 246 define passageways 237 and 239 which provide a fluid communication pathway between annular passageway 216 and, ultimately, tubes 76 and 77 of transport system 48.

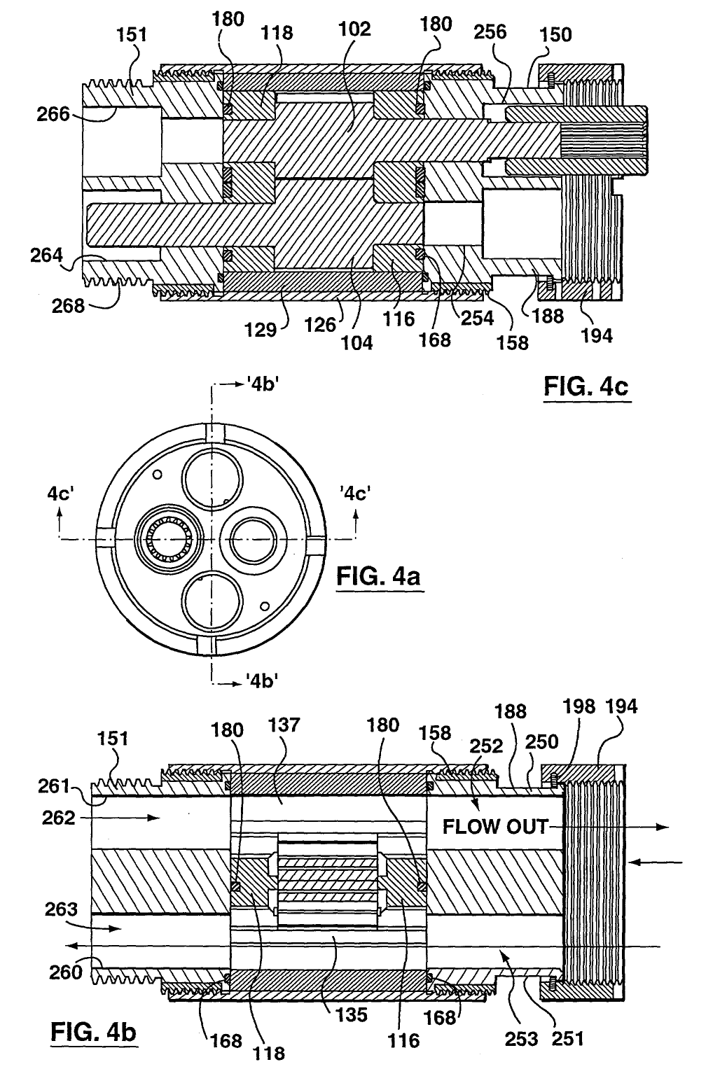

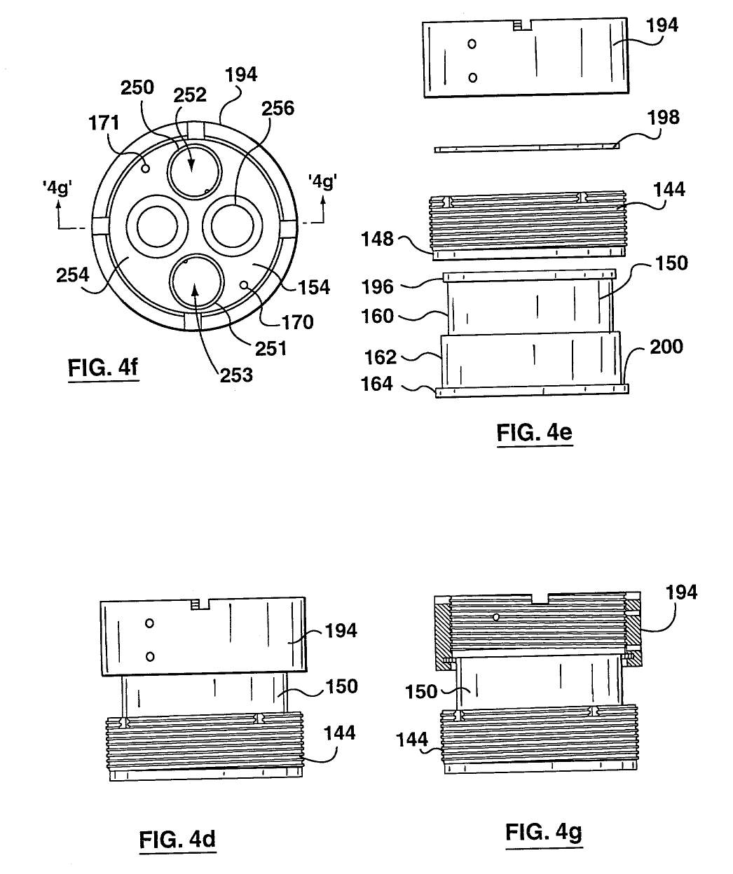

Upper motor assembly 82 has a union nut 194 as described above, which engages threaded end portion 230 of motor section inlet plate 80. As shown in FIGS. 2c and 5c, plate 150 has a pair of parallel longitudinally extending through bores 250 and 251 defining hydraulic fluid intake and exhaust passages 252 and 253 that communicate with the respective intake and exhaust passages 135 and 137 of the positive displacement gear assembly 100 containing gears 106 and 108 of unit 82. Taken on the perpendicular longitudinal cross-section, plate 150 has a pair of parallel countersunk bores 254 and 256. Bores 254 and 256 dead end at the blocked interface with motor section inlet plate 80 in line with dead ends 241 and 242. Bore 256 is occupied by splined end 114 of stub shaft 106 of gear 102, such that shaft 106 is an idler. Bore 254 is unoccupied. As shown in FIG. 4c, an internally splined coupler is indicated as 258. Coupler 258 is employed when assembly 82 is an intermediate motor assembly (i.e., neither the top nor the bottom unit in a string of several motor assemblies). Coupler 258 is removed when used in a top unit such as assembly 82 since there is no shaft above it in the string with which to connect, and coupler 258 would otherwise foul the blind end face of plate 80.

As shown in FIG. 4b, plate 151 of upper motor assembly 82 has a pair of parallel longitudinally extending through bores 260 and 261 defining hydraulic fluid intake and exhaust passages 262 and 263 that communicate with the respective intake and exhaust passages 135 and 137 of the positive displacement gear section containing gears 106 and 108 of unit 218. Taken on the perpendicular longitudinal cross-section of FIG. 4c, plate 151 has a pair of parallel countersunk bores 264 and 266. Bores 264 and 266 are open clear through to corresponding countersunk bores of the next adjacent motor unit, namely lower motor unit 84. Bore 264 is occupied by splined end 108 of stub shaft 104 of gear 104. Bore 266 is unoccupied.

Upper plate 270 of lower motor assembly 84 is identical to plate 150 of upper motor unit 82. Union nut 194 of plate 270 of lower motor assembly 84 engages the external thread 268 of plate 151 of upper motor assembly 82. In this case an internally splined transmission coupling shaft 272 engages the downwardly extending splines of stub shaft 108 of upper motor assembly 82, and the upwardly extending splines of stub shaft 106 of lower motor assembly 84 such that when the upper shaft is driven, torque is transmitted by coupling shaft 272 to the lower shaft. The broadened countersunk portions of bores 254 and 256 accommodate coupling shaft 272.

Plate 271 of lower motor assembly 84 is shown in FIGS. 2c, 5b and 5c. It is identical to plate 151 of upper motor assembly 82 except insofar as it does not have hydraulic fluid transfer passages corresponding to passages 262 and 263, but rather is dead ended opposite the ends of passages 135 and 137 of unit 100 of assembly 84, thus closing the end of the hydraulic pump fluid circuit. As a result, the only ways for hydraulic fluid to pass from the pressure, or supply side is through the positive displacement gear sets of either upper motor assembly 82 or lower motor assembly 84. Given the positive engagement of coupling shaft 272, these gearsets are locked together to turn at the same rate, and any output torque is available on driven stub shaft 108 of lower motor assembly 84.

Motor section outlet plate 86 has a medial, radially outwardly extending flange 274, an upwardly extending first body end portion 276, and a second, downwardly extending second body end portion 278. End portion 276 has an external flange 280 and a union nut 194 by which it is mounted to the external threads 282 of lower plate 271 of lower motor assembly 84. Flange 274 has a circumferential step into which the bottom margin of casing 214 seats, and is welded. Second body end portion 278 is externally threaded to accept a union nut 283 attached to pump section 64. As shown in FIGS. 2c and 3g, motor outlet plate 212 has a longitudinal bore 282 that extends inwardly (i.e., upwardly, from downward face 284 past the longitudinal position of the upward facing shoulder 286 of flange 280. A lateral notch, or aperture 288 is formed in second end portion 278 to permit fluid communication between passage 216 and the passage 290 defined by bore 282 and aperture 288. Motor section outlet plate 86 has a second longitudinal bore 292 aligned with shaft 108 of lower motor assembly 220, and a tail shaft, or transfer shaft, in the nature of driven shaft 294 extends from a splined coupling 272 mounted to shaft 108 of lower motor assembly 84 to connect with upper pump assembly 90.

Upper pump assembly 90 is shown in FIGS. 2c, 3h, 6a, 6b and 6c. Upper pump assembly 90 has a first, or upper plate 300 and a lower plate 301 to upper and lower sides of a gear assembly 101. As noted above, gear assembly 101 is identical in construction to gear assembly 100, but is somewhat larger in diameter as shown in FIG. 2c, and has a thicker shrink fit casing 127. Upper plate 300 has a cylindrical body having a first, upward face 302, a second, downward face 304, a first, upward portion 306 next to face 302 having a flange and a union nut 194 as described above, and a smooth cylindrical exterior surface 308. In the same manner as plate 150, upper plate 300 also has a second, or lower outwardly stepped cylindrical portion 310 having a smooth surface and an end flange 312 to be captured by a retaining ring, or sleeve 144 as described above, and fixed in position relative to external pump casing 127. Plate 300 has a first pair of parallel longitudinally extending, round cylindrical, through-bores 312 and 314. Bore 312 defines within its walls is an outflow, or exhaust passage 316. Bore 314 defines within it an inlet passage 318, or an inlet manifold leading to gear assembly 100 of upper pump assembly 90. An cross-bore 320 intersects bore 314 and provides inlet ports by which production fluid can enter passage 314. Whereas exhaust passage 316 is open to passage 290 of motor outlet section plate 86, inlet passage 318 is dead ended at plate 86.

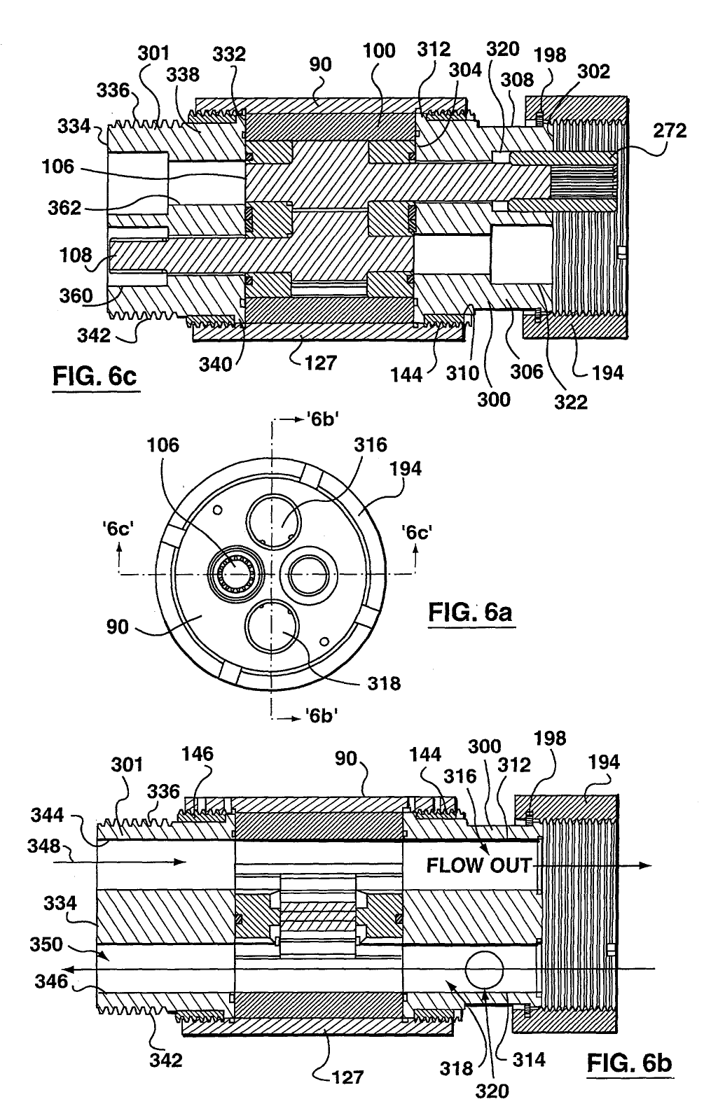

In the perpendicular cross section, shown in FIG. 6c, plate 300 has a pair of first and second parallel longitudinal countersunk bores 320 and 322, bore 320 being occupied by stub shaft 106 of upper pump assembly 90, and bore 322 being unoccupied. An inwardly splined coupling mates with driven shaft 294 of plate 86 described above such that driving rotation of shaft 294 will tend to turn the gearset of upper pump assembly 90, thus driving production fluid from passage 318 to passage 316.

Lower plate 301 has a cylindrical body having a first, upward face 332, a second, downward face 334, a first, upward portion 336 next to face 332. In the same manner as member 151, lower plate 301 also has a first, or upper outwardly stepped cylindrical portion 338 having a smooth surface and an end flange 340 to be captured by a retaining sleeve 146 as described above, and fixed in position relative to external pump casing 311. Lower plate 301 also has a second, lower portion having a threaded cylindrical exterior surface 342. Plate 301 has a first pair of parallel longitudinally extending round cylindrical, through-bores 344 and 346. Bore 344 defines within its walls an outflow, or exhaust passage 348 that is in fluid communication with passage 316 and with the exhaust side of the positive displacement gearset of lower pump assembly 92. Bore 346 defines within it an inlet passage 350, or an inlet manifold leading to gear assembly 100 of lower pump assembly 92. Inlet passage 350 is open to inlet passage 318, making a common inlet manifold passage.

In the perpendicular cross section, shown in FIG. 6C, plate 301 has a pair of first and second parallel longitudinal countersunk bores 360 and 362, bore 360 being occupied by stub shaft 108 of upper pump assembly 90, and bore 362 being unoccupied.

Lower pump assembly 92 also has an upper plate 370 and a lower plate 371. Upper plate 370 is identical to upper plate 300. Lower plate 371 is similar to lower plate 301, but while having drive shaft bores, 372 and 373, is dead ended opposite the intake and exhaust passages 135 and 137 of the positive displacement gearset of lower pump assembly 92.

A perforated external casing 375 is carried outside upper and lower pump assemblies 90 and 92, and has ports, or apertures 376 by while production fluid can enter and find its way to intake passages 318.

When all of the above units are assembled in their aligned positions, it can be seen that when hydraulic fluid is supplied under pressure to motor section 62, the various gearshafts are forced to turn, thus driving the upper and lower pump sections to urge production fluid from the inlet side, represented by passages 318, to the outlet or exhaust side, represented by passages 316. The production fluid is then forced upwardly through the series of inter-connected production fluid passages, namely item numbers 290, 216, 237 and 239 to passages 74 and 75 of transport system 48, and thence to the well head.

Although a preferred embodiment of production unit has now been described, various alternative embodiments can be used. For example, with appropriate substitution of top and bottom plates and with appropriate lengths of casing tubes, a motor-and-pump production unit can be assembled with only a single motor unit, or a single pump unit. Since the upper motor and pump units respectively have lower end fittings that correspond to their own top end fittings, it is possible to string together a large number of such motor assemblies, or such pump assemblies, in intermediate positions as may be required at a given site depending on the desired flowrate and the physical properties, viscosity, of the production fluid, such as viscosity. The number of motor assemblies need not equal the number of pump assemblies, and may be greater or lesser as may be appropriate given the circumstances of the particular well from which production fluid is to be extracted.

Other types of positive displacement gear pumps can also be employed. FIGS. 8d and 8e show views of a positive displacement gear assembly 400 having a first, or internal gear 402, an external ring gear 404 mounted eccentrically relative to internal gear 402, and a spacer in the nature of a floating crescent 406 mounted in the gap between gears 402 and 404. External gear 404 is mounted concentrically about the longitudinal axis 401 of gear assembly 400, generally, the axis of rotation of gear 402 being eccentric relative to axis 401. The internal concave arcuate face 408 of crescent 406 is formed on a circular arc having a radius of curvature corresponding to the outer tip radius of internal gear 402. The external, convex arcuate face 410 of crescent 406 is formed on a circular arc having a radius of curvature corresponding to the tip radius of the inwardly extending teeth of ring gear 404. As gears 402 and 404 turn, the interstitial spaces between the teeth define fluid conveying cavities, and when the teeth mesh the cavity volumes are diminished so that the fluid is forced out. Consequently, as the gears turn, fluid is transferred between intake and exhaust port regions 412 and 414. Alternatively, when a pressure differential is established between port regions 412 and 414 gear assembly 400 acts as a motor providing output torque to shaft 416 upon which inner gear 402 is mounted. In either case, the direction of rotation will determine which is the intake port, and which is the exhaust. Shaft 416 is splined at both ends 418 and 420, permitting power transfer transmission to and from adjacent pump or motor units.

The gear set formed by gears 402 and 404, crescent 406 and shaft 416 is mounted within a round cylindrical annulus, or housing, namely ceramic insert 422, which is itself contained with a shrink-fit external steel tube casing 424. As above, casing 424 has a tensile pre-load, and imposes a compressive radial pre-load on insert 422.

First and second end plates are indicated as 426 and 428. Each has a counter sunk eccentric bore 430 for close fitting accommodation of a ceramic bushing 432 which seats about shaft 416 and has an end face that abuts one face of inner gear 402. Bore 430 is sufficiently large at its outer end to permit engagement of an internally splined coupling by which torque can be transferred to an adjacent shaft, in a manner analogous to that described above. Each of end plates 426 and 428 has a first end face 427 that locates adjacent a face of ring gear 404, and has an outer peripheral seal groove and a static seal 429 seated therein to bear against a shoulder of insert 422. Locating means, in the nature of indexing sockets and mating dowel pins 433 determine the orientation of end plates 426 and 428 relative to the respective axes of rotation of gears 402 and 404, and to each other.

End plate 426 is nominally the upward end plate of the assembly, and has a flange 434 to be engaged by a retaining ring 436. Retaining ring 436 is externally threaded and engages the internally threaded overhanging upward end skirt 437 of casing 424 in the manner of retainer 44 and skirt 140 described above. A union nut 438 and retaining ring 439 engage and end face flange 440 in the manner of union nut 194 described above. End plate 428 is the same as end plate 426 externally, with the exception that the distal portion 441 is externally threaded to mate with a union nut of an adjacent pump or motor assembly, or other fitting.

Internally, end plates 426 and 428 each have a pair of parallel, round cylindrical longitudinally extending bores 442 and 444 let inward from the end face most distant from gears 402 and 404, and extending toward gears 402 and 404, defining respective internal passageways. Each has an enlarged port 446, 448 in the nature of an arcuate, circumferentially extending rebate at the respective end face 427 of plate 426 or 428 that is located adjacent to gears 402 and 404. These rebates act as intake and exhaust galleries for gears 402 and 404, the function depending on the direction of rotation of the gears.

Given the symmetrical nature of assembly 400, it can be seen that it can be operated either as a motor or as a pump, and, with appropriate interconnection transition plates analogous to plates 80, and 86, several units can be ganged together as parallel (or, serial) pump stages or motor stages, with the shafting and splined couplings permitting transmission of mechanical torque between the various stages.

A further alternative gear assembly is shown in FIGS. 8f and 8g as 450. All of the components of assembly 450 are the same as those of assembly 400 of FIGS. 4c and 4d described above, except that in place of the positive displacement gear assembly of gear 402, gear 404 and crescent 406, assembly 450 employs a positive displacement gear assembly in the nature of a gerotor assembly 452. Gerotor assembly 452 has an inner gerotor element 454 and a mating outer gerotor element 456. Outer gerotor element 456 is concentric with the longitudinal centerline 458 of assembly 450 generally, and inner gerotor element 454 is mounted on an eccentric parallel axis. In the manner of gerotors generally, as the gerotor elements turn, variable geometry cavities defined between respective adjacent lobes of the inner and outer elements expand and contract, drawing in fluid at an intake side 460, and expelling it at an exhaust region 464 (as before, intake and exhaust depend on the direction of rotation of the elements). As above, appropriate porting permits assembly 450 to be used as a motor or a pump, and several units can be linked together to form a multi-stage pump or multistage motor. Shafting and splined couplings can be used to transfer mechanical torque from stage to stage.

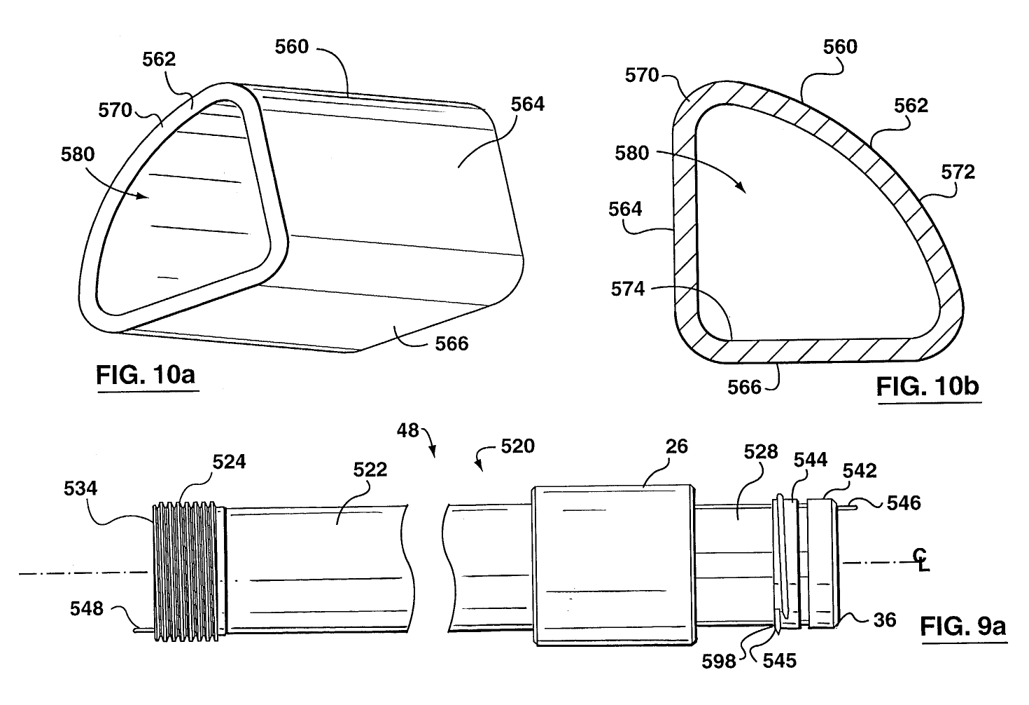

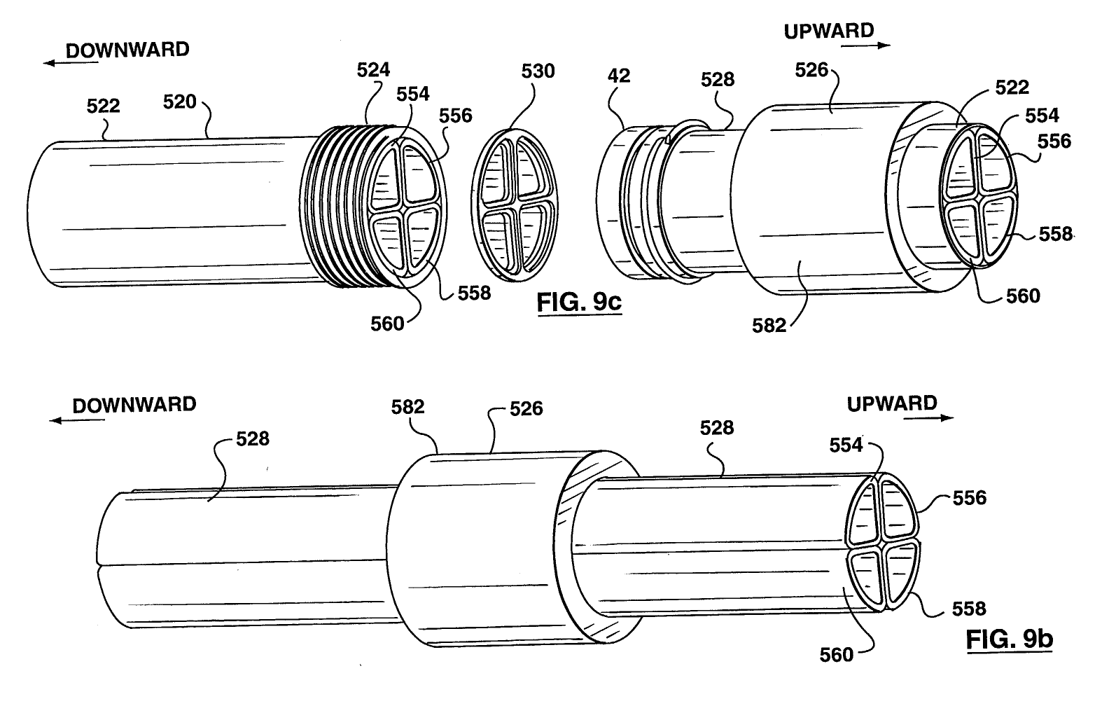

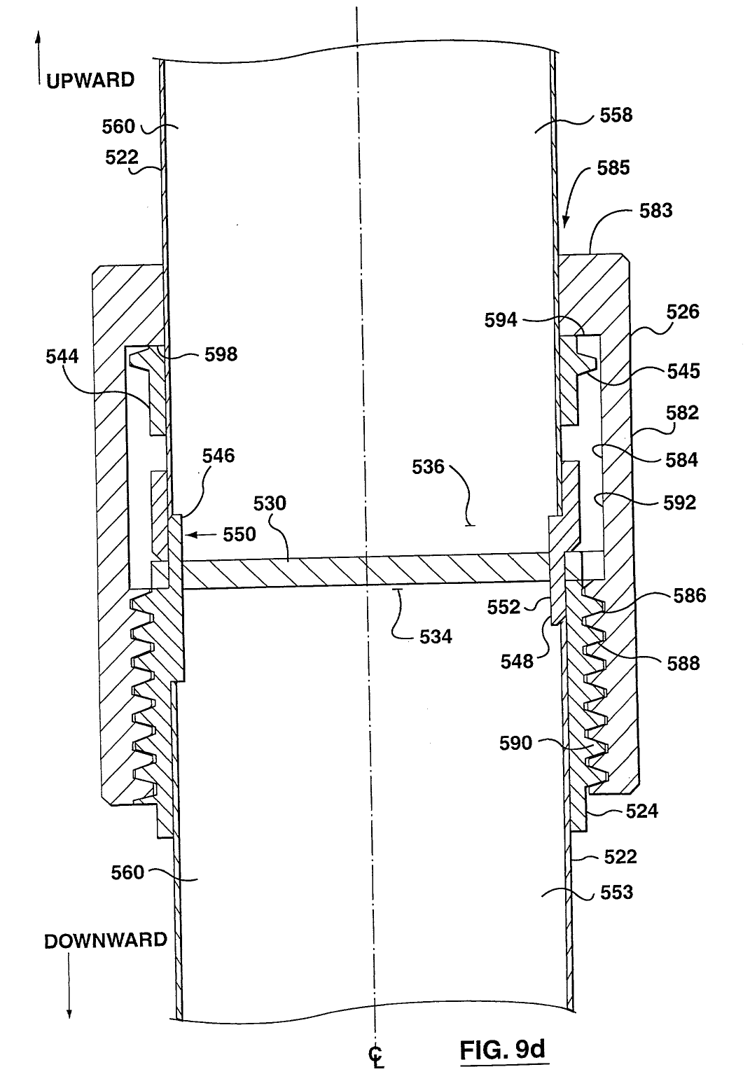

Operation of the foregoing preferred and alternative embodiments of production units and their associated motor or pump units requires a supply of hydraulic fluid, and transport of the production fluid to the surface. To that end, transport system 48 employs a multi-passage conduit that is now described in greater detail. By way of a general overview, and referring to FIGS. 9a, 9b, and 9c, a pipe string “joint” in the nature of a modular pipe assembly is shown as 520. It has a casing 522 and an interconnection in the nature of a male fitting 524 at one end, and a female fitting in the nature of a female coupling 526 at the other, such that a string of modular pipe assemblies 520 can be joined together. A pipe bundle 528 is contained within casing 522, and a seal 530 of matching profile to bundle 528 is clamped between adjacent assemblies 520 when a string is put together. Notably, the pipes of bundle 528 lie side by side, rather than being nested concentrically one within the other. For the purposes of illustration, the length of the assembly or assemblies shown is shorter in the illustrations than in actual fact. In use a typical assembly length would be 10 or 12 m (32.8 to 39.5 ft), and the pipe bundle diameter would be about 15 cm (6 in.). Other lengths and diameters can be used. The longitudinal, or axial direction is indicated in the figures by center line axis CL of casing 522.

During deployment or installation, pipe assembly 520 is mounted to another pipe assembly, then introduced into a well bore a few feet, another similar section of pipe is added, the string is advanced, another string is added and so on. Although assembly 520 can be used in a horizontal well bore application, the assembly at the well head is generally in the vertical orientation. Thus FIGS. 9a, 9b, and 9c each have arrows indicating “Up” and “Down” such as well rig workers would see at the well head.

Examining the Figures in greater detail, casing 522 is round and cylindrical and serves as an external bundle retainer. It is preferred that casing 522 be shrink fit about bundle 528. In the preferred embodiment of FIG. 9a, casing 522 is made from mild steel pipe. The type of material used for the casing may tend to depend on the application. For example, a stainless steel or other alloy may be preferred for use in more aggressive environments, such as high sulfur wells. Casing 522 has a pair of first and second ends, 534 and 536. Male fitting 524 is mounted at first end 534. Female coupling 528 is mounted about casing 522, and is longitudinally slidable and rotatable with respect to second end 536. A retaining ring 542 is mounted flush with second end 536, and a start flange, 544, is mounted inboard of ring 542. Start flange 544 is a cylindrical collar having one turn of a single external thread 545. As shown in FIG. 9c, first and second indexing dogs 546 and 548, protrude longitudinally, or axially, from first and second ends 524 and 526 respectively. At corresponding positions indicated by arrows 550 and 552, assembly 520 has sockets into which dogs of other mating pipe assemblies can locate. During assembly of a string of pipes at the well head, dogs 546 and 548 engage matching sockets in the next adjacent assemblies, thus ensuring their relative alignment as the string is assembled.

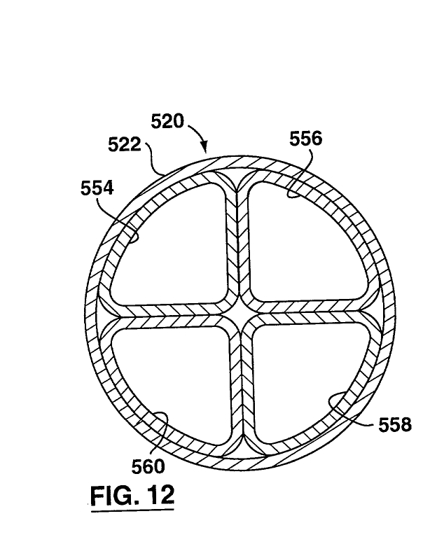

As shown in FIGS. 9b and 9c, each of pipe assemblies 520 has four parallel conduit members, or pipe sections, in the nature tubes, 554, 556, 558 and 560 arranged in a bundle within casing 522. In the FIGS. 9b and 9c all of tubes 554, 556, 558 and 560 have the same cross-section, being that shown in FIGS. 10a and 12. That section has the shape of a right angle sector of a circle, that is, a pie-shaped piece approximating a quarter of a pie, with smoothly radiused corners. In the preferred embodiment of FIGS. 10a and 12, tube 560 has an outer arcuate portion 562, having an outside radius of curvature of 2.75 inches to suit a pipe having an inside, shrink fit diameter of 5.5 inches. Tube 560 also has a first side 564, and a second side 566 at right angles to first side 564. Arcuate portion 562 and sides 564 and 566 are joined at their respective common vertices to define a closed wall section, 570. Section 570 has an external wall surface 572, and an internal wall surface 574, each having respective first and second straight portions and an arcuate portion, with radiused corners.

Section 570 is made by roll forming a round pipe of known pressure rating into irregular pie shape shown. This can be done in progressive roll forming stages. Section 570 is a seamless pipe. Other types of pipe can also be used, such as seamed ERW pipe, or an extruded pipe capable of holding the pressures imposed during operation.

Internal wall surface 574 defines a passageway, indicated generally as 580, along which a fluid can be conveyed in the axial, or longitudinal direction, whether upward or downward. When casing 522 is shrunk fit in place, tubes 554, 556, 558 and 560 have a combined outer surface approximating a circle and are held in place against each other's respective first and second external side portions by friction.

In the cross-section of FIG. 9d, a pair of assemblies 520 are shown as connected in an engaged or coupled position. Female coupling 526 has a circular cylindrical body 582 having an internal bore 584 defined therewithin. At one end body 582 has an end wall 583 having an opening 585 defined centrally therein, opening 585 being sized to fit closely about casing 522. At the other end body 582 has a cylindrical land 586 that has an internal thread 588 for mating engagement with the external male thread 590 of male fitting 524 of an adjacent assembly 520.

Body 582 also has an internal relief 592 defined therein. Relief 592 is bounded by a first shoulder 594, on its nominally upward end. As assembled, first shoulder 594 bears against the upward facing annular end face 598 of start flange 544, and, as female internal thread 588 engages male external thread 590, the upper and lower assemblies 520 are drawn together, compressing seal 530 in the process.

When the upper and lower assemblies 520 are not joined together, female coupling 526 is backed off such that the first turn of internal thread 588 downstream of relief 592 engages the single external thread 545 of start flange 544. This results in female coupling 526 being held up at a height to permit a well worker to make sure that seal 530 is in place on the downward assembly 520, and indexed correctly relative to dogs 546 and 548, before the two units are joined together.

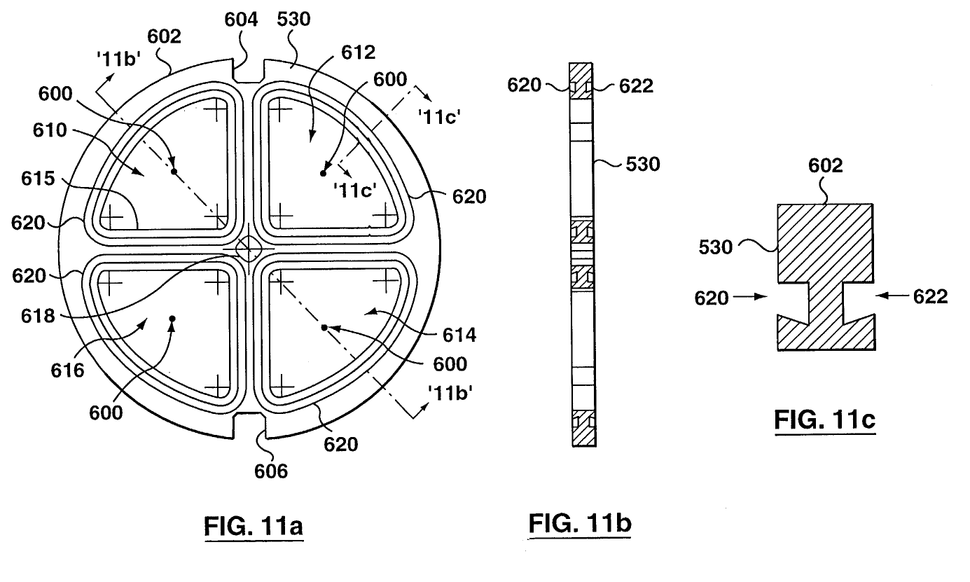

Seal 530 is shown in plan view in FIG. 11a. It has a circular external circumference 602, with first and second dog locating notches 604 and 606 shown diametrally opposed from each other, notches 604 and 606 acting as alignment governors, or indexing means. When located on the end of a pipe assembly 520, notch 604, for example, locates on dog 546, and when two such pipe assemblies are joined, the other dog, namely dog 548 of the second pipe assembly, will locate in the opposite notch, namely notch 606. Although the preferred embodiment is shown in FIG. 11a, the notches need not be on 180 degree centers, but could be on an asymmetric, or offset 90 degrees, such as may be suitable for ensuring that the dogs line up as indexing devices to ensure that adjoining sections of pipe, when assembled have the correct passages in alignment. Seal 530 has four quarter pie shaped openings 610, 612, 614, and 616 defined on 90 degree centers, such as correspond to the general shape of the cross-section of passageway 580 of each of tubes 554, 556, 558 and 560. With these openings so defined, seal 530 is left with a four-armed spider 615 in the form of a cross. A fifth, rather smaller, generally square aperture 618, is formed centrally in spider 615, such as may be suitable for permitting the passage of electrical wires for a sensing or monitoring device. As can be seen in the sectional view of FIGS. 11b and 11c, seal 530 has grooves 620 and 622 formed on opposite sides (that is, front and back, or upper and lower as installed), each of grooves 620 and 622 having the shape, in plan view, to correspond to the shape of a protruding lip of the end of each of tubes 554, 556, 558 and 560. The mating shapes locate positively, again ensuring alignment, and, when squeezed under the closing force or female coupling 526, a seal is formed, tending to maintain the integrity, that is, the segregation, of the various passageways from pipe to pipe as the string is put together.

The approximate centroids of the passages of tubes 554, 556, 558, and 560 are indicated as 600. It will be noted that unlike nested pipes, whether concentric or eccentric, none of the passages defined within any or the respective pipes is occluded by any other pipe, and none of the centroids of any of the pipes fall within the profiles of any of the other pipes. Put another way, the hydraulic diameter of each of the pipes is significantly greater than the hydraulic diameter that would result if four round cylindrical tubes were nested concentrically, one inside the other, with equivalent wall thicknesses. The useful area within casing 522 may also tend to be greater since the sum of the peripheries of the tubes, multiplied by their thickness may tend to yield a lesser area than the wall cross-sectional area of four concentric pipes.

The embodiment of FIG. 12 is currently preferred. Such an embodiment has a number of advantages. First, all of the pipe segments are of the same cross-section, which simplifies manufacture, assembly and replacement. Second, in an application where the multi-passage conduit assembly so obtained is used to drive a down-hole hydraulic pump, one passage can be use to carry hydraulic fluid under pressure, another passage can be used to carry the hydraulic fluid return flow, a third passage can carry the production fluid that is to be pumped out of the well, and the fourth passage or the central gap can be used for electrical cabling, such as may be required for monitoring equipment.

In the side-by-side embodiment of FIG. 12, none of the cross-sectional areas of any of the individual tube sections overlaps the area of any other, as would be otherwise be the case in a nested pipe arrangement. Further, it is a matter of mathematical calculation that the centroid of the cross-sectional area of any of the tube sections of the preferred embodiment of FIG. 12, lies outside the cross-sectional area of any of the other tubes that are in side-by-side relationship. The hydraulic diameter, Dh of a passageway is given by the formula:

Dh=4A/P

Where:

A=Cross sectional area of the passage; and

P=Perimeter of the passage.

In FIG. 12, the hydraulic diameter of the tubes is less than the quotient obtained by dividing the perimeter of the particular tube by π. Similarly the cross-sectional area of at least two of the tubes is less than the square of the perimeter divided by 4π.

Various embodiments of the invention have now been described in detail. Since changes in and or additions to the above-described best mode may be made without departing from the nature, spirit or scope of the invention, the invention is not to be limited to those details, but only by the appended claims.

We claim:

1. A fluid displacement assembly comprising:
a first gear;
a second gear; and
a housing having a chamber defined therein to accommodate said gears;
said first and second gears being mounted within said housing in meshing relationship;
said housing having an inlet by which fluid can flow to said gears and an outlet by which fluid can flow away from said gears;
said gears being operable to urge fluid from said inlet to said outlet; and
at least a portion of said housing being made from a ceramic material.

2. The gear assembly of claim 1 wherein said assembly is operable at temperatures in excess of 180° F.

3. The gear assembly of claim 2 wherein said assembly is operable at temperatures at least as high as 350° F.

4. The gear assembly of claim 1 wherein said ceramic material is part of a ceramic member, and said ceramic member is mounted within a casing.

5. The gear assembly of claim 4 wherein said ceramic material has a compressive pre-load.

6. The gear assembly of claim 1 wherein said first and second gears are spur gears.

7. The gear assembly of claim 1 wherein said first gear is a spur gear and said second gear is a ring gear mounted eccentrically about said first gear.

8. The gear assembly of claim 7 wherein a ceramic partition member is mounted within said ring gear between said first gear and said second gear.

9. The gear assembly of claim 1 wherein said first and second gears are a pair of gerotor gears.

10. The gear assembly of claim 1 wherein:
said gears are sandwiched between a pair of first and second yokes mounted to either axial sides thereof
each of said yokes has a pair of first and second bores formed therein to accommodate said first and second shafts;
each of said yokes has a gear engagement face located next to said gears;
each of said gear engagement faces has a peripheral margin conforming to said arcuate portions of said internal wall of said housing; and
each of said yokes is biased to lie against said gears.

11. A gear pump comprising:
a first gear, a second gear, and a housing having a chamber defined therein to accommodate said gears;
said first gear being mounted on a shaft, said shaft having an axis of rotation;
said first and second gears being mounted in said housing in meshing engagement;
said housing having an inlet by which fluid can flow to said gears and an outlet by which fluid can flow away from said gears; and
said shaft being mounted in ceramic bushings within said housing.

12. The gear pump of claim 11 wherein said ceramic bushings include ceramic inserts mounted in a metal body.

13. A gear pump assembly comprising:
a first gear, a second gear, and a housing having a cavity defined therein to accommodate said first and second gears;
said first and second gears being mounted in meshing relationship within said housing;
said housing having an inlet by which fluid can flow to said gears and an outlet by which fluid can flow away from said gears;
said gears being operable to displace fluid from said inlet to said outlet;
said first gear being mounted on a first shift, said shaft having an axis of rotation;
said first and second gears each having a first end face lying in a first plane perpendicular to said axis of rotation; and
a moveable wall mounted within said housing to engage said first end faces of said gears;
said moveable wall having a ceramic surface oriented to bear against said first end faces of said first and second gears.

14. The gear pump of claim 13 wherein said moveable wall is a head of a piston and in operation said piston is biased toward said first end faces of said first and second gears.

15. The gear pump of claim 14 wherein said piston is hydraulically biased toward said gears.

16. The gear pump of claim 13 wherein:
each of said first and second gears has a second end face lying in a second plane spaced from said first plane; and
a second moveable wall is mounted within said housing to bear against said second end faces of said first and second gears.

17. The gear pump of claim 16 wherein in operation, both of said moveable walls are biased toward said gears.

18. The gear pump of claim 16 wherein said end walls are heads of respective first and second pistons, said pistons being moveable parallel to said axis of rotation.

19. The gear pump of claim 13 wherein said ceramic surface is a plasma carried on a metal substrate.

20. The gear pump of claim 13 wherein:
said second gear is mounted on a second shaft extending parallel to said first shaft; and
said ceramic surface is formed on a body having a first bore defined therein to accommodate said first shaft and a second bore defined therein to accommodate said second shaft;
said body being displaceable along said shafts.

21. The gear pump of claim 20 wherein at least one of said bores has a wall presenting a ceramic bushing surface to one of said shafts

22. The gear pump of claim 20 wherein said body has a passageway formed therein to facilitate flow of fluid.

23. The gear pump of claim 20 wherein said body has passageways formed therein to facilitate flow of fluid to and from said inlet and said outlet.

24. A gear pump assembly comprising:
a pair of first and second mating gears, mounted on respective first and second parallel shafts in meshed relationship;
a housing for said gears, said housing having an inlet by which fluid can flow to said gears and an outlet by which fluid can flow away from said gears;
said gears being operable to urge fluid from said inlet to said outlet;
said housing including a gear surround;
said gear surround having two overlapping bores defined therein conforming to said gears in meshed relationship; and
said surround presenting a ceramic internal surface to said gears.

25. The gear pump assembly of claim 24 wherein said surround is formed of a transformation toughened zirconia.

26. The gear pump assembly of claim 25 wherein said surround is made of a ceramic monolith.

27. The gear pump assembly of claim 24 wherein said surround has a compressive pre-load.

28. The gear pump assembly of claim 24 wherein said surround is mounted within a shrink fit casing member.

29. The gear pump assembly of claim 30 wherein said ceramic monolith has a co-efficient of thermal expansion corresponding to said gears.

30. The gear pump assembly of claim 24 wherein a movable endwall is mounted to ride in said overlapping bores.

31. The gear pump assembly of claim 24 wherein:
said shafts each have an axis of rotation and said gears each have first and second end faces lying in first and second spaced apart parallel planes, said parallel planes extending perpendicular to said axis;
a movable piston is mounted to ride within said overlapping bores; and
said piston has a face oriented to engage said first end faces of said gears.

32. A gear pump assembly comprising:
a first gear mounted on a first shaft, said first shaft having a first axis of rotation;
a second gear mounted on a second shaft, said second shaft having a second axis of rotation;
said axes lying in a common plane;
said first and second gears being mounted to mesh together in a first region between said axes;
a gear surround having an internal wall defining a cavity shaped to accommodate said gears;
said internal wall having a first portion formed on an arc conforming to said first gear and a second portion, formed on another arc to conform to said second gear;
said first and second portions lying away from said first region;
said internal wall having a third portion between said first and second portions;
said third portion lying abreast of said first region, said third portion having a first passageway formed therein to carry fluid to said cavity adjacent said gears to one side of said plane;
said internal wall having a fourth portion lying between said first and second portions;
said fourth portion lying abreast of said first region to the other side of said plane;
said fourth portion having a second passageway formed therein to carry fluid from said cavity; and
said gears being operable to transfer fluid from said first passageway to said second passageway.

33. A well production apparatus for transporting a production fluid from a downhole portion of a well to a well head, said apparatus comprising:
a transport assembly having a first end located in the downhole portion of the well and a second end located at the wellhead;
a gearpump mounted to said first end of said transport assembly;
said transport assembly having at least one passageway defined therein for conducting production fluid from said first end to said second end;
said transport assembly having a power transmission member extending between said first and second ends thereof;
said transmission member being connected to said gear pump to permit said gear pump be driven from the wellhead; and
said gear pump being operable to urge production fluid from said first end of said transport assembly to the wellhead.

34. A method of moving production fluid from a well to a wellhead comprising the steps of:
mounting a gear pump to a first end of a transport apparatus from the wellhead;
introducing the transport apparatus into the well and locating the gear pump in a downhole production region of the well; and
driving the gear pump from outside the well to urge production fluid from the production region to the wellhead.

35. The method of claim 34 wherein said method includes the steps of:
providing a passageway in the transport apparatus for carrying production fluid from the production region to the wellhead; and
providing a power transmission member to carry power for the wellhead to the gear pump.
